(19) United States
(12) Patent Application Publication
(10) Pub. No.: US 2020/0090279 A1
(43) Pub. Date: Mar. 19, 2020

(54) Dollar Depository Receipts and Electronic Friends Trading and Repo Transactions

(71) Applicant: CFPH, LLC, New York, NY (US)

(72) Inventors: Philip M. Ginsberg, New York, NY (US); Howard W. Lutnick, New York, NY (US)

(21) Appl. No.: 16/692,175

(22) Filed: Nov. 22, 2019

Related U.S. Application Data
(63) Continuation of application No. 13/844,299, filed on Mar. 15, 2013, now abandoned.

(51) Int. Cl. G06Q 40/06

(52) U.S. Cl. CPC G06Q 40/06

(57) ABSTRACT

According to various embodiments, systems and methods are provided for creating and managing a group account, e.g., via a social network platform. A first user may request to create an account. The first user may designate a plurality of accountholders for the account and a subset of accountholders authorized to transact trades and other transactions for the account. The first user may also specify rules governing how accountholders may be added or removed from the account. The account may be activated. An authorized trader may conduct trades and other transactions on behalf of the account, such as repo transactions and the trading of Dollar Depository Receipts. Accountholders may be added or removed in accordance with the rules.

### RELATED APPLICATIONS

This application is a continuation of U.S. patent application Ser. No. 13/844,299 filed on Mar. 15, 2013, which is hereby incorporated herein by reference.

### FIELD OF THE INVENTION

This application is generally related to systems and methods for trading, exchanging, creating and managing accounts.

### BACKGROUND

Prior systems enable a plurality of users to connect with one another, associate electronic objects with a plurality of users, and communicate with one another in substantially real time. For example, Facebook enables users to create a user social network account, join friends to a user's network, send messages to other users, and receive status updates from other users. Facebook also allows users to create groups, specify parameters of each group, invite friends to join the group, cause group updates to be sent to participating members and to encourage group actions.

### BRIEF SUMMARY OF THE INVENTION

Various systems and methods are provided for trading, exchanging, creating, and managing accounts, and to expand investment, charitable, and education opportunities. In various embodiments of the invention, user groups can be formed to allow the coordination and sharing of investment and borrowing and lending activities. While investment and borrowing and lending opportunities are marketed and offered to a large segment of the working population a large segment of the social networking population are underserved by existing institutions. One of the purposes of social networking systems is to distribute information to facilitate decision making By building on social networking concepts, various embodiments will make it easier to buy and sell financial instruments, teach the foundations of savings and investment, and expand the universe of investors. In accordance with this and other objects of the invention systems and procedures are employed to create a new trading instrument called a Dollar Depository Receipt, DDR, that represents a fixed dollar amount of a security, e.g., $10 of Apple stock. In one aspect of the invention an individual can share this $10 purchase of Apple stock with a select group of individuals that belongs to a created group. When another member of the group purchases a $10 Google DDR then the systems can join these two purchases to form a portfolio that can be shared by the two members of the group so that each participant owns the equivalent of $5 of Apple stock and $5 of Google stock. Various aspects of the invention control the addition of new members to the group and the decision apparatus that allows purchases and sales, distributions and terminations for the joint portfolio. One aspect of the invention allows for the borrowing and lending using the assets of the portfolio as collateral. Another aspect of the invention allows for the creation of Limited Risk Accounts that will allow for a monetary limit to be imposed for deposits to accommodate the opening of accounts by minors and to allay concerns regarding Anti Money Laundering regulations. Further features of the invention will monitor trading preferences and activities of members of the group to provide for alternative trading candidates that suggest diversification or similarity and to provide a platform for intra and inter group competitions. In addition, portfolio managers (participants) can arrange to share risks by mutual exchange and sharing of risks and returns. The invention also allows for tutorials that span economics and finance.

### BRIEF DESCRIPTION OF THE FIGURES

FIG. 1 depicts a system according to at least one embodiment of the systems disclosed herein.

FIG. 2 depicts a flow diagram for creating and managing a group account according to at least one embodiment of the methods disclosed herein.

FIG. 3 depicts a flow diagram for issuing and trading dollar depository receipts according to at least one embodiment of the methods disclosed herein.

FIG. 4 depicts an exemplary interface for creating and managing an account according to at least one embodiment of the methods disclosed herein.

### DETAILED DESCRIPTION

The following sections I-XI provide a guide to interpreting the present application.

### I. TERMS

The following sections I-XI provide a guide to interpreting the present application.

### II. TERMS

The term “product” means any machine, manufacture and/or composition of matter, unless expressly specified otherwise.

The term “process” means a process, algorithm, method or the like, unless expressly specified otherwise.

Each process (whether called a method, algorithm or otherwise) inherently includes one or more steps, and therefore all references to a “step” or “steps” of a process have an inherent antecedent basis in the mere description of a process, or in the mere recitation of the term ‘process’ or a like term. Accordingly, any reference in a claim to a ‘step’ or ‘steps’ of a process has sufficient antecedent basis.

The term “invention” and the like mean “the one or more inventions disclosed in this application”, unless expressly specified otherwise.

The terms “an embodiment”, “embodiment”, “embodiments”, “the embodiment”, “the embodiments”, “one or more embodiments”, “some embodiments”, “certain embodiments”, “one embodiment”, “another embodiment” and the like mean “one or more (but not all) embodiments of the invention”, unless expressly specified otherwise.

The term “variation” of an invention means an embodiment of the invention, unless expressly specified otherwise.

The term “indication” is used in an extremely broad sense. An “indication” of a thing should be understood to include anything that may be used to determine the thing.

An indication of a thing may include an electronic message that identifies the thing (e.g., an identification of a widget by a serial number affixed to the widget, an identification of a widget by one or more characteristics of the widget). An indication of a thing may include information that may be used to compute and/or look-up a thing (e.g., information identifying a machine of which a widget is a part that may be used to determine the widget). An indication of a thing may specify things that are related to the thing (e.g., characteristics of the thing, a name of the thing, a name of a thing related to the thing). An indication of a thing may not specify things that are related to the thing (e.g., a letter “a” may be an indication of a widget of a computer system that is configured to interpret the letter “a” to identify the widget). An indication of a thing may include a sign, a symptom, and/or a token of the thing. An indication, for example, may include a code, a reference, an example, a link, a signal, and/or an identifier. An indication of a thing may include information that represents, describes, and/or otherwise is associated with the thing.

A transformation of an indication of a thing may be an indication of the thing (e.g., an encrypted indication of a thing may be an indication of the thing). An indication of a thing may include the thing itself, a copy of the thing, and/or a portion of the thing. An indication of a thing may be meaningless to a thing that is not configured to understand the indication (e.g., a person may not understand that a letter “a” indicates a widget but it may nonetheless be an indication of the widget because the computer system may determine the widget from the letter “a”). It should be understood that the fact that an indication of a thing may be used to determine the thing does not mean that the thing or anything else is determined. An indication of a thing may include an indication of any number of the thing unless specified otherwise. An indication of a thing may include an indication of other things (e.g., an electronic message that indicates may things). (Indication can be used as a very broad term in claim language. For example: receiving an indication of a financial instrument.)

The term “represent” means (1) to serve to express, designate, stand for, or denote, as a word, symbol, or the like does; (2) to express or designate by some term, character, symbol, or the like; (3) to portray or depict or present the likeness of, as a picture does; or (4) to serve as a sign or symbol of.

A reference to “another embodiment” in describing an embodiment does not imply that the referenced embodiment is mutually exclusive with another embodiment (e.g., an embodiment described before the referenced embodiment), unless expressly specified otherwise. Similarly, the mere fact that two (or more) embodiments are referenced does not imply that those embodiments are mutually exclusive.

One embodiment of the invention may include or cover or embrace more than one other embodiment of the invention. For example, a first embodiment comprising elements a, b, and c may cover a second embodiment that comprises elements a, b, c, and d as well as a third embodiment covering elements a, b, c, and e. Similarly, each of the first, second, and third embodiments may cover a fourth embodiment comprising elements a, b, c, d, and e.

The terms “including”, “comprising” and variations thereof mean “including but not necessarily limited to”, unless expressly specified otherwise. Thus, for example, the sentence “the machine includes a red widget and a blue widget” means the machine includes the red widget and the blue widget, but may possibly include one or more other items as well.

The term “consisting of” and variations thereof mean “including and also limited to”, unless expressly specified otherwise. Thus, for example, the sentence “the machine consists of a red widget and a blue widget” means the machine includes the red widget and the blue widget, but does not include anything else.

The term “compose” and variations thereof mean “to make up the constituent parts of, component of or member of”, unless expressly specified otherwise. Thus, for example, the sentence “the red widget and the blue widget compose a machine” means the machine includes the red widget and the blue widget.

The term “exclusively compose” and variations thereof mean “to make up exclusively the constituent parts of, to be the only components of, or to be the only members of”, unless expressly specified otherwise. Thus, for example, the sentence “the red widget and the blue widget exclusively compose a machine” means the machine consists of the red widget and the blue widget (i.e. and nothing else).

The terms “a”, “an” and “the” refer to “one or more”, unless expressly specified otherwise. Thus, for example, the phrase “a widget” means one or more widgets, unless expressly specified otherwise. Similarly, after reciting the phrase “a widget”, a subsequent recitation of the phrase “the widget” means “the one or more widgets”. Accordingly, it should be understood that the word “the” may also refer to a specific term having antecedent basis. For example, if a paragraph mentions “a specific single feature” and then refers to “the feature,” then the phrase “the feature” should be understood to refer to the previously mentioned “a specific single feature.” (It should be understood that the term “a” in “a specific single feature” refers to “one” specific single feature and not “one or more” specific single features.)

The term “plurality” means “two or more”, unless expressly specified otherwise.

The term “herein” means “in the present application, including anything which may be incorporated by reference”, unless expressly specified otherwise.

The phrase “at least one of”, when such phrase modifies a plurality of things (such as an enumerated list of things), means any combination of one or more of those things, unless expressly specified otherwise. For example, the phrase “at least one of a widget, a car and a wheel” means either (i) a widget, (ii) a car, (iii) a wheel, (iv) a widget and a car, (v) a widget and a wheel, (vi) a car and a wheel, or (vii) a widget, a car and a wheel. The phrase “at least one of”, when such phrase modifies a plurality of things does not mean “one of each of” the plurality of things. For example, the phrase “at least one of a widget, a car and a wheel” does not mean “one widget, one car and one wheel”.

Numerical terms such as “one”, “two”, etc. when used as cardinal numbers to indicate quantity of something (e.g., one widget, two widgets), mean the quantity indicated by that numerical term, but do not mean at least the quantity indicated by that numerical term. For example, the phrase “one widget” does not mean “at least one widget”, and therefore the phrase “one widget” does not cover, e.g., two widgets.

The phrase “based on” does not mean “based only on”, unless expressly specified otherwise. In other words, the phrase “based on” covers both “based only on” and “based at least on”. The phrase “based at least on” is equivalent to the phrase “based at least in part on”. For example, the phrase “element A is calculated based on element B and element C” covers embodiments where element A is calculated as the product of B times C (in other words, A=B×C), embodiments where A is calculated as the sum of B plus C (in other words, A=B+C), embodiments where A is calculated as a product of B times C times D, embodiments where A is calculated as a sum of the square root of B plus C plus D times E, and so on.

The term “represent” and like terms are not exclusive, unless expressly specified otherwise. For example, the term “represents” does not mean “represents only”, unless expressly specified otherwise. For example, the phrase “the data represents a credit card number” covers both “the data represents only a credit card number” and “the data represents a credit card number and the data also represents something else”.

The term “whereby” is used herein only to precede a clause or other set of words that express only the intended result, objective or consequence of something that is explicitly recited before the term “whereby”. Thus, when the term “whereby” is used in a claim, the clause or other words that the term “whereby” modifies do not establish specific further limitations of the claim or otherwise restrict the meaning or scope of the claim.

The terms “e.g”, “such as” and like terms mean “for example”, and thus do not limit the term or phrase they explain. For example, in the sentence “the computer sends data (e.g., instructions, a data structure) over the Internet”, the term “e.g.” explains that “instructions” are an example of “data” that the computer may send over the Internet, and also explains that “a data structure” is an example of “data” that the computer may send over the Internet. However, both “instructions” and “a data structure” are merely examples of “data”, and other things besides “instructions” and “a data structure” can be “data”.

The term “respective” and like terms mean “taken individually”. Thus if two or more things have “respective” characteristics, then each such thing has its own characteristic, and these characteristics can be different from each other but need not be. For example, the phrase “each of two machines has a respective function” means that the first of the two machines has a function and the second of the two machines has a function as well. The function of the first machine may or may not be the same as the function of the second machine.

The term “i.e.” and like terms mean “that is”, and thus limits the term or phrase it explains. For example, in the sentence “the computer sends data (i.e., instructions) over the Internet”, the term “i.e.” explains that “instructions” are the “data” that the computer sends over the Internet.

A numerical range includes integers and non-integers in the range, unless expressly specified otherwise. For example, the range “1 to 10” includes the integers from 1 to 10 (e.g., 1, 2, 3, 4, . . . 9, 10) and non-integers (e.g., 1.0031415926, 1.1, 1.2, . . . 1.9).

Where two or more terms or phrases are synonymous (e.g., because of an explicit statement that the terms or phrases are synonymous), instances of one such term or phrase does not mean instances of another such term or phrase must have a different meaning. For example, where a statement renders the meaning of “including” to be synonymous with “including but not limited to”, the mere usage of the phrase “including but not limited to” does not mean that the term “including” means something other than “including but not limited to”.

### II. DETERMINING

The term “determining” and grammatical variants thereof (e.g., to determine a price, determining a value, the determination of an object which meets a certain criterion) is used in an extremely broad sense. The term “determining” encompasses a wide variety of actions and therefore “determining” can include calculating, computing, processing, deriving, investigating, looking up (e.g., looking up in a table, a database or another data structure), rendering into electronic format or digital representation, ascertaining and the like. Also, “determining” can include receiving (e.g., receiving information), accessing (e.g., accessing data in a memory) and the like. Also, “determining” can include resolving, selecting, choosing, establishing, and the like.

The term “determining” does not imply certainty or absolute precision, and therefore “determining” can include estimating, extrapolating, predicting, guessing, averaging and the like.

The term “determining” does not imply that mathematical processing must be performed, and does not imply that numerical methods must be used, and does not imply that an algorithm is used.

The term “determining” does not imply that any particular device must be used. For example, a computer need not necessarily perform the determining.

The term “determining” may include “calculating”. The term “calculating” should be understood to include performing one or more calculations. Calculating may include computing, processing, and/or deriving. Calculating may be performed by a computing device. For example, calculating a thing may include applying an algorithm to data by a computer processor and generating the thing as an output of the processor.

The term “determining” may include “referencing”. The term “referencing” should be understood to include making one or more reference, e.g., to a thing. Referencing may include querying, accessing, selecting, choosing, reading, and/or looking-up. The act of referencing may be performed by a computing device. For example, referencing a thing may include reading a memory location in which the thing is stored by a processor.

The term “determining” may include “receiving”. For example, receiving a thing may include taking in the thing. In some embodiments, receiving may include acts performed to take in a thing, such as operating a network interface through which the thing is taken in. In some embodiments, receiving may be performed without acts performed to take in the thing, such as in a direct memory write or a hard wired circuit. Receiving a thing may include receiving a thing from a remote source that may have calculated the thing.

### III. FORMS OF SENTENCES

Where a limitation of a first claim would cover one of a feature as well as more than one of a feature (e.g., a limitation such as “at least one widget” covers one widget as well as more than one widget), and where in a second claim that depends on the first claim, the second claim uses a definite article “the” to refer to that limitation (e.g., “the widget”), this mere usage does not imply that the first claim covers only one of the feature, and this does not imply that the second claim covers only one of the feature (e.g., “the widget” can cover both one widget and more than one widget).

When an ordinal number (such as “first”, “second”, “third” and so on) is used as an adjective before a term, that ordinal number is used (unless expressly specified otherwise) merely to indicate a particular feature, such as to distinguish that particular feature from another feature that is described by the same term or by a similar term, but that ordinal number does not have any other meaning or limiting effect—it is merely a convenient name. For example, a “first widget” may be so named merely to distinguish it from, e.g., a “second widget”. Thus, the mere usage of the ordinal numbers “first” and “second” before the term “widget” does not indicate any other relationship between the two widgets, and likewise does not indicate any other characteristics of either or both widgets. For example, the mere usage of the ordinal numbers “first” and “second” before the term “widget” (1) does not indicate that either widget comes before or after any other in order or location; (2) does not indicate that either widget occurs or acts before or after any other in time; and (3) does not indicate that either widget ranks above or below any other, as in importance or quality. The mere usage of ordinal numbers does not define a numerical limit to the features identified with the ordinal numbers. For example, the mere usage of the ordinal numbers “first” and “second” before the term “widget” does not indicate that there are exactly two widgets.

When a single device, article or other product is described herein, in another embodiment more than one device or article (whether or not they cooperate) may alternatively be used in place of the single device or article that is described. Accordingly, the functionality that is described as being possessed by a device may alternatively be possessed by more than one device or article (whether or not they cooperate) in another embodiment.

Similarly, where more than one device, article or other product is described herein (whether or not they cooperate), in another embodiment a single device or article may alternatively be used in place of the more than one device or article that is described. For example, a plurality of computer-based devices may be substituted with a single computer-based device. In some embodiments, such a plurality of computer-based devices may operate together to perform one step of a process such as is common in grid computing systems. In some embodiments, such a plurality of computer-based devices may operate provide added functionality to one another so that the plurality may operate to perform one step of a process such as is common in cloud computing systems. (Conversely, a single computer-based device may be substituted with multiple computer-based devices operating in cooperation with one another. For example, a single computing device may be substituted with a server and a workstation in communication with one another over the internet) Accordingly, the various functionality that is described as being possessed by more than one device or article may alternatively be possessed by a single device or article.

The functionality and/or the features of a single device that is described may, in another embodiment, be alternatively embodied by one or more other devices which are described but are not explicitly described as having such functionality or features. Thus, other embodiments need not include the described device itself, but rather can include the one or more other devices which would, in those other embodiments, have such functionality or features.

### IV. DISCLOSED EXAMPLES AND TERMINOLOGY ARE NOT LIMITING

Neither the Title (set forth at the beginning of the first page of the present application) nor the Abstract (set forth at the end of the present application) is to be taken as limiting in any way the scope of the disclosed invention, is to be used in interpreting the meaning of any claim or is to be used in limiting the scope of any claim. An Abstract has been included in this application merely because an Abstract is required under 37 C.F.R. § 1.72(b).

The headings of sections provided in the present application are for convenience only, and are not to be taken as limiting the disclosure in any way.

Numerous embodiments are described in the present application, and are presented for illustrative purposes only. The described embodiments are not, and are not intended to be, limiting in any sense. The disclosed invention is widely applicable to numerous embodiments, as is readily apparent from the disclosure. One of ordinary skill in the art will recognize that the disclosed invention may be practiced with various modifications and alterations, such as structural, logical, software, and electrical modifications. Although particular features of the disclosed invention may be described with reference to one or more particular embodiments and/or drawings, it should be understood that such features are not limited to usage in the one or more particular embodiments or drawings with reference to which they are described, unless expressly specified otherwise.

Though an embodiment may be disclosed as including several features, other embodiments of the invention may include fewer than all such features. Thus, for example, a claim may be directed to less than the entire set of features in a disclosed embodiment, and such claim would not be interpreted as requiring features beyond those features that the claim expressly recites.

No embodiment of method steps or product elements described in the present application constitutes the invention claimed herein, or is essential to the invention claimed herein, or is coextensive with the invention claimed herein, except where it is either expressly stated to be so in this specification or (with respect to a claim and the invention defined by that claim) expressly recited in that claim.

Any preambles of the claims that recite anything other than a statutory class shall be interpreted to recite purposes, benefits and possible uses of the claimed invention, and such preambles shall not be construed to limit the claimed invention.

The present disclosure is not a literal description of all embodiments of the invention. Also, the present disclosure is not a listing of features of the invention which must be present in all embodiments.

All disclosed embodiments are not necessarily covered by the claims (even including all pending, amended, issued and canceled claims). In addition, a disclosed embodiment may be (but need not necessarily be) covered by several claims. Accordingly, where a claim (regardless of whether pending, amended, issued or canceled) is directed to a particular embodiment, such is not evidence that the scope of other claims do not also cover that embodiment.

Devices that are described as in communication with each other need not be in continuous communication with each other, unless expressly specified otherwise. On the contrary, such devices need only transmit to each other as necessary or desirable, and may actually refrain from exchanging data most of the time. For example, a machine in communication with another machine via the Internet may not transmit data to the other machine for long period of time (e.g. weeks at a time). In addition, devices that are in communication with each other may communicate directly or indirectly through one or more intermediaries. Devices are in communication with one another if they are capable of at least one-way communication with one another. For example, a first device is in communication with a second device if the first device is capable of transmitting information to the second device. Similarly, the second device is in communication with the first device if the second device is capable of receiving information from the first device.

A description of an embodiment with several components or features does not imply that all or even any of such components or features are required. On the contrary, a variety of optional components are described to illustrate the wide variety of possible embodiments of the present invention. Unless otherwise specified explicitly, no component or feature is essential or required.

Although process steps, algorithms or the like may be described or claimed in a particular sequential order, such processes may be configured to work in different orders. In other words, any sequence or order of steps that may be explicitly described or claimed does not necessarily indicate a requirement that the steps be performed in that order. The steps of processes described herein may be performed in any order possible. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention, and does not imply that the illustrated process is preferred.

Although a process may be described as including a plurality of steps, that does not imply that all or any of the steps are preferred, essential or required. Various other embodiments within the scope of the described invention include other processes that omit some or all of the described steps. Unless otherwise specified explicitly, no step is essential or required.

Although a process may be described singly or without reference to other products or methods, in an embodiment the process may interact with other products or methods. For example, such interaction may include linking one business model to another business model. Such interaction may be provided to enhance the flexibility or desirability of the process.

Although a product may be described as including a plurality of components, aspects, qualities, characteristics and/or features, that does not indicate that any or all of the plurality are preferred, essential or required. Various other embodiments within the scope of the described invention include other products that omit some or all of the described plurality.

An enumerated list of items (which may or may not be numbered) does not imply that any or all of the items are mutually exclusive, unless expressly specified otherwise. Likewise, an enumerated list of items (which may or may not be numbered) does not imply that any or all of the items are comprehensive of any category, unless expressly specified otherwise. For example, the enumerated list “a computer, a laptop, and a PDA” does not imply that any or all of the three items of that list are mutually exclusive and does not imply that any or all of the three items of that list are comprehensive of any category.

An enumerated list of items (which may or may not be numbered) does not imply that any or all of the items are equivalent to each other or readily substituted for each other.

All embodiments are illustrative, and do not imply that the invention or any embodiments were made or performed, as the case may be.

### V. COMPUTING

It will be readily apparent to one of ordinary skill in the art that the various processes described herein may be implemented by, e.g., appropriately programmed general purpose computers, special purpose computers and computing devices. Typically a processor (e.g., one or more microprocessors, one or more microcontrollers, one or more digital signal processors) will receive instructions (e.g., from a memory or like device), and execute those instructions, thereby performing one or more processes defined by those instructions. Instructions may be embodied in, e.g., one or more computer programs, one or more scripts.

The term “compute” shall mean to determine using a processor in accordance with a software algorithm.

A “processor” means one or more microprocessors, central processing units (CPUs), computing devices, microcontrollers, digital signal processors, graphics processing units (GPUs) or like devices or any combination thereof, regardless of the architecture (e.g., chip-level multiprocessing or multi-core, RISC, CISC, Microprocessor without Interlocked Pipeline Stages, pipelining configuration, simultaneous multithreading, microprocessor with integrated graphics processing unit, GPGPU).

A “computing device” means one or more microprocessors, central processing units (CPUs), computing devices, microcontrollers, digital signal processors, graphics card, mobile gaming device, or like devices or any combination thereof, regardless of the architecture (e.g., chip-level multiprocessing or multi-core, RISC, CISC, Microprocessor without Interlocked Pipeline Stages, pipelining configuration, simultaneous multithreading).

Thus a description of a process is likewise a description of an apparatus for performing the process. The apparatus that performs the process can include, e.g., a processor and those input devices and output devices that are appropriate to perform the process. For example, a description of a process is a description of an apparatus comprising a processor and memory that stores a program comprising instructions that, when executed by the processor, direct the processor to perform the method.

The apparatus that performs the process can include a plurality of computing devices that work together to perform the process. Some of the computing devices may work together to perform each step of a process, may work on separate steps of a process, may provide underlying services that other computing devices that may facilitate the performance of the process. Such computing devices may act under instruction of a centralized authority. In another embodiment, such computing devices may act without instruction of a centralized authority. Some examples of apparatus that may operate in some or all of these ways may include grid computer systems, cloud computer systems, peer-to-peer computer systems, computer systems configured to provide software as a service, and so on. For example, the apparatus may comprise a computer system that executes the bulk of its processing load on a remote server but outputs display information to and receives user input information from a local user computer, such as a computer system that executes VMware software.

Further, programs that implement such methods (as well as other types of data) may be stored and transmitted using a variety of media (e.g., computer readable media) in a number of manners. In some embodiments, hard-wired circuitry or custom hardware may be used in place of, or in combination with, some or all of the software instructions that can implement the processes of various embodiments. Thus, various combinations of hardware and software may be used instead of software only.

The term “computer-readable medium” refers to any medium, a plurality of the same, or a combination of different media, that participate in providing data (e.g., instructions, data structures) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

The term “tangible computer-readable medium” refers to a “computer-readable medium” that comprises a hardware component, such as optical or magnetic disks.

Various forms of computer readable media may be involved in carrying data (e.g. sequences of instructions) to a processor. For example, data may be (i) delivered from RAM to a processor; (ii) carried over a wireless transmission medium; (iii) formatted and/or transmitted according to numerous formats, standards or protocols, such as Ethernet (or IEEE 802.3), wireless local area network communication defined by the IEEE 802.11 specifications whether or not they are approved by the WiFi Alliance, SAP, ATP, Bluetooth™, and TCP/IP, TDMA, CDMA, and 3G; and/or (iv) encrypted to ensure privacy or prevent fraud in any of a variety of ways well known in the art.

The term “database” refers to any electronically-stored collection of data that is stored in a retrievable format.

The term “data structure” refers to a database in a hardware machine such as a computer.

The term “network” means a series of points or nodes interconnected by communication paths. For example, a network can include a plurality of computers or communication devices interconnected by one or more wired and/or wireless communication paths. Networks can interconnect with other networks and contain subnetworks.

The term “predetermined” means determined beforehand, e.g., before a present time or a present action. For example, the phrase “displaying a predetermined value” means displaying a value that was determined before the act of displaying.

The term “condition” means (1) a premise upon which the fulfillment of an agreement depends, or (2) something essential to the appearance or occurrence of something else.

The term “transaction” means (1) an Exchange or transfer of goods, services, or funds, or (2) a communicative action or activity involving two parties or things that reciprocally affect or influence each other.

Thus a description of a process is likewise a description of a computer-readable medium storing a program for performing the process. The computer-readable medium can store (in any appropriate format) those program elements which are appropriate to perform the method. For example, a description of a process is a description of a computer-readable storage medium that stores a program comprising instructions that, when executed by a processor, direct the processor to perform the method.

Just as the description of various steps in a process does not indicate that all the described steps are required, embodiments of an apparatus include a computer or computing device operable to perform some (but not necessarily all) of the described process.

Likewise, just as the description of various steps in a process does not indicate that all the described steps are required, embodiments of a computer-readable medium storing a program or data structure include a computer-readable medium storing a program that, when executed, can cause a processor to perform some (but not necessarily all) of the described process.

Where databases are described, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats (including relational databases, object-based models and/or distributed databases) could be used to store and manipulate the data types described herein. Likewise, object methods or behaviors of a database can be used to implement various processes, such as the described herein. In addition, the databases may, in a known manner, be stored locally or remotely from a device which accesses data in such a database.

Various embodiments can be configured to work in a network environment including a computer that is in communication (e.g., via a communications network) with one or more devices. The computer may communicate with the devices directly or indirectly, via any wired or wireless medium (e.g. the Internet, LAN, WAN or Ethernet, Token Ring, a telephone line, a cable line, a radio channel, an optical communications line, commercial on-line service providers, bulletin board systems, a satellite communications link, a combination of any of the above). Each of the devices may themselves comprise computers or other computing devices, such as those based on the Intel®, Pentium®, or Centrino™, Atom™ or Core™ processor, that are adapted to communicate with the computer. Any number and type of devices may be in communication with the computer.

In an embodiment, a server computer or centralized authority may not be necessary or desirable. For example, the present invention may, in an embodiment, be practiced on one or more devices without a central authority. In such an embodiment, any functions described herein as performed by the server computer or data described as stored on the server computer may instead be performed by or stored on one or more such devices.

Where a process is described, in an embodiment the process may operate without any user intervention. In another embodiment, the process includes some human intervention (e.g., a step is performed by or with the assistance of a human).

As used herein, the term “encryption” refers to a process for obscuring or hiding information so that the information is not readily understandable without special knowledge. The process of encryption may transform raw information, called plaintext, into encrypted information. The encrypted information may be called ciphertext, and the algorithm for transforming the plaintext into ciphertext may be referred to as a cipher. A cipher may also be used for performing the reverse operation of converting the ciphertext back into plaintext. Examples of ciphers include substitution ciphers, transposition ciphers, and ciphers implemented using rotor machines.

In various encryption methods, ciphers may require a supplementary piece of information called a key. A key may consist, for example, of a string of bits. A key may be used in conjunction with a cipher to encrypt plaintext. A key may also be used in conjunction with a cipher to decrypt ciphertext. In a category of ciphers called symmetric key algorithms (e.g., private-key cryptography), the same key is used for both encryption and decryption. The sanctity of the encrypted information may thus depend on the key being kept secret. Examples of symmetric key algorithms are DES and AES. In a category of ciphers called asymmetric key algorithms (e.g., public-key cryptography), different keys are used for encryption and decryption. With an asymmetric key algorithm, any member of the public may use a first key (e.g., a public key) to encrypt plaintext into ciphertext. However, only the holder of a second key (e.g., the private key) will be able to decrypt the ciphertext back in to plaintext. An example of an asymmetric key algorithm is the RSA algorithm.

### VI. CONTINUING APPLICATIONS

The present disclosure provides, to one of ordinary skill in the art, an enabling description of several embodiments and/or inventions. Some of these embodiments and/or inventions may not be claimed in the present application, but may nevertheless be claimed in one or more continuing applications that claim the benefit of priority of the present application.

Applicants intend to file additional applications to pursue patents for subject matter that has been disclosed and enabled but not claimed in the present application.

### VII. 35 U.S.C. § 112, PARAGRAPH 6

In a claim, a limitation of the claim which includes the phrase “means for” or the phrase “step for” means that 35 U.S.C. § 112, paragraph 6, applies to that limitation.

In a claim, a limitation of the claim which does not include the phrase “means for” or the phrase “step for” means that 35 U.S.C. § 112, paragraph 6 does not apply to that limitation, regardless of whether that limitation recites a function without recitation of structure, material or acts for performing that function. For example, in a claim, the mere use of the phrase “step of” or the phrase “steps of” in referring to one or more steps of the claim or of another claim does not mean that 35 U.S.C. § 112, paragraph 6, applies to that step(s).

With respect to a means or a step for performing a specified function in accordance with 35 U.S.C. § 112, paragraph 6, the corresponding structure, material or acts described in the specification, and equivalents thereof, may perform additional functions as well as the specified function.

Computers, processors, computing devices and like products are structures that can perform a wide variety of functions. Such products can be operable to perform a specified function by executing one or more programs, such as a program stored in a memory device of that product or in a memory device which that product accesses. Unless expressly specified otherwise, such a program need not be based on any particular algorithm, such as any particular algorithm that might be disclosed in the present application. It is well known to one of ordinary skill in the art that a specified function may be implemented via different algorithms, and any of a number of different algorithms would be a mere design choice for carrying out the specified function.

Therefore, with respect to a means or a step for performing a specified function in accordance with 35 U.S.C. § 112, paragraph 6, structure corresponding to a specified function includes any product programmed to perform the specified function. Such structure includes programmed products which perform the function, regardless of whether such product is programmed with (i) a disclosed algorithm for performing the function, (ii) an algorithm that is similar to a disclosed algorithm, or (iii) a different algorithm for performing the function.

Where there is recited a means for performing a function that is a method, one structure for performing this method includes a computing device (e.g., a general purpose computer) that is programmed and/or configured with appropriate hardware to perform that function.

Also included is a computing device (e.g., a general purpose computer) that is programmed and/or configured with appropriate hardware to perform that function via other algorithms as would be understood by one of ordinary skill in the art.

### VIII. DISCLAIMER

Numerous references to a particular embodiment do not indicate a disclaimer or disavowal of additional, different embodiments, and similarly references to the description of embodiments which all include a particular feature do not indicate a disclaimer or disavowal of embodiments which do not include that particular feature. A clear disclaimer or disavowal in the present application will be prefaced by the phrase “does not include” or by the phrase “cannot perform”.

### IX. INCORPORATION BY REFERENCE

Any patent, patent application or other document referred to herein is incorporated by reference into this patent application as part of the present disclosure, but only for purposes of written description and enablement in accordance with 35 U.S.C. § 112, paragraph 1, and should in no way be used to limit, define, or otherwise construe any term of the present application, unless without such incorporation by reference, no ordinary meaning would have been ascertainable by a person of ordinary skill in the art. Such person of ordinary skill in the art need not have been in any way limited by any embodiments provided in the reference. Conversely, the definitions provided in this application should not be used to limit, define, or otherwise construe any term of any document incorporated herein by reference. The definitions set forth explicitly in this application are controlling notwithstanding the description of particular embodiments that may be incompatible with the definition(s).

Any incorporation by reference does not, in and of itself, imply any endorsement of, ratification of or acquiescence in any statements, opinions, arguments or characterizations contained in any incorporated patent, patent application or other document, unless explicitly specified otherwise in this patent application.

### X. PROSECUTION HISTORY

In interpreting the present application (which includes the claims), one of ordinary skill in the art shall refer to the prosecution history of the present application, but not to the prosecution history of any other patent or patent application, regardless of whether there are other patent applications that are considered related to the present application, and regardless of whether there are other patent applications that share a claim of priority with the present application.

### DETAILED DESCRIPTION OF EXEMPLARY EMBODIMENTS

According to various embodiments, investment accounts may be created and actively managed on a network such as a social networking website (e.g., similar to Facebook) wherein users may create and manage individual and group accounts comprising cash (and/or other financial instruments such as stock, bonds, derivatives, etc.). Limited Risk Accounts, LRAs, may be created that limit the amount of funds that can be deposited into the account. LRAs by their nature may have lower regulatory requirements for their creation and supervision and are meant to attract younger individuals who would find it difficult to have control of their investment decisions under the existing regulatory environment. Exemplary accounts that may be created include individual trading accounts, retirement accounts, hedge funds, group trading accounts (e.g., a group of users pooling assets for trading in the stock market), special purpose group accounts (e.g., an account to fund a specific party or event), and other investment accounts and/or other accounts. Users may create and join accounts in a manner similar to creating and joining groups on other sites such as Facebook. Users may also block certain users or user groups from access to an account or information about an account.

According to various embodiments, methods, apparatus, and computer-readable media are provided for creating and managing a group account, e.g., in a social network. A request to create an account may be received from a first user. A designation of a plurality of accountholders of the account may be received from the first user. A designation of a subset of the plurality of accountholders authorized to transfer account assets out of the account may be received from the first user. The subset of the plurality of accountholders may comprise a second user. A designation of rules specifying how accountholders may be added or removed from the account may be received from the first user. The account may be activated. A request to trade an asset of the account may be received from the second user. The requested trade may occur. A new accountholder may be added to the account in accordance with the rules specifying how accountholders may be added or removed.

In some embodiments, a sale of a Dollar Depository receipt may be offered. The act of offering may comprise causing information about the Dollar Depository Receipt to be displayed at a display device. The Dollar Depository Receipt may represent a fractional interest in a financial instrument traded on an exchange. The information may comprise a time associated with a pricing of the Dollar Depository Receipt and an indication of the financial instrument. A request to purchase a first quantity of the Dollar Depository Receipt may be received from a second user. Payment for the first quantity of the Dollar Depository Receipt may be received from the first user. Indicia of ownership of the first quantity of the Dollar Depository Receipt may be transmitted to the user.

In some embodiments, accounts may engage in repo transactions.

In some embodiments, an account/fund can be owned or shared by multiple users. Account ownership may be divided into “shares”, which may be transferred to other users of the social networking site, e.g., by clicking on a “transfer” button. Accounts and account assets (shares, cash, other assets) may be bought, sold, or traded between and among different users and user groups. Accounts and account assets may also be exchanged redeemed by the system for value, such as for products or services offered by the system. For example, the system may offer four movie tickets and a $20 gift certificate to McDonalds for $50 of account value (e.g., in stocks and cash).

In some embodiments, some of the accounts may be investment accounts. For example, a user may create a group account for investing in technology stocks. Different users may be authorized to purchase stocks using account funds. The system can assess each user's performance in picking stocks. For example, users who consistently pick stocks that perform well can earn reward points or qualify as a “star” trader. The account may specify that the only the two highest-rated stock pickers have authority to purchase or sell stocks in the account.

Account Creation and Governance

In some embodiments, each user and group account may be established, governed, or otherwise defined by various parameters. Such parameters may comprise a team name, charter, logo, coded signal, membership, withdrawal and veto rights and/or rules of engagement and compensation. Such parameters may also comprise:

(1) Any initial requirements or conditions for creating the group account. For example, in some embodiments the account may become active only when a default or pre-specified number of users (such as three users) or user types (e.g., at least one “star investor”) accept an invitation to join from one or more users having authority to invite new members. Alternatively or in addition, the account may require a minimum threshold of funds or assets (e.g., $10 total cash, $20 of assets, or $15 of cash and assets combined based on a determined value of assets) before the account can be activated.

(2) The default or original percentage/distribution of ownership of the account among founding members, and/or rules for determining initial percentage ownership whenever a new user or entity joins the account. For example, initially joining members may share a pro rata share of the account according to the amount contributed (e.g., founding accountholders contributing $20, $30, and $50 to an account of $100 total hold a 20%, 30%, and 50% share of the account's funds, respectively). In some embodiments, non founding members may have to pay a fee or forego or pay a benefit or payment in order to join an existing group, e.g., to give up a percentage of a subsequent period's profit on the account.

In some embodiments, rules may specify that a “controlling” accountholder or investing accountholder may be compensated (e.g., for the “controlling” or investing responsibilities) with a percentage of account ownership or proceeds (e.g., 2% of the account, or 5% of any account income such as capital gains or dividend income). In some embodiments, rules may specify compensation to third parties, e.g., 5% of income is paid to or accrues to an outside investor or manager who handles account investments.

(3) Rules governing trading and the transfer of funds from the account (e.g., which users have authority to transfer funds, and under what conditions). For example, users may specify during account creation that only users designated as “controlling” users of the account may transfer funds out of the account. In some embodiments, rules may set maximum transfer amounts, e.g., for a given period (e.g., no more than the lesser of S5 or 20% of the account's current cash balance per day or week). In some embodiments, rules may specify which user, users, or user types (e.g., designated “controlling” users) may transfer such funds. In some embodiments, rules may specify that all or a majority of “controlling” users or all account participants must agree on any transfer, or any transfer that satisfies certain criteria (e.g., the amount is greater than the lesser of 5 or 20% of the account's current cash balance and thus requires majority approval from controlling users or all account participants.

(4) Rules governing who, when, and how users may “cash out”, redeem, or trade all or a portion of their proportional ownership of the account. For example, rules may specify that users account controllers may leave an account any time, but other users may only leave and cash out from the account upon approval from one, some, or all controlling users or account participants. In some embodiments, an authorized trader of the account may transfer a departing user's cash or assets from the group account to an account of the departing user. In some embodiments, departing users may wait one or more trading days (e.g., 5 business days) before they receive their cash or assets.

(5) Rules governing which user(s) have authority to trade stocks or otherwise manage funds in the account. In some embodiments, the group may vote (e.g., electronically) on what to buy or sell and when (e.g., end of day). In some embodiments, default settings or the group may appoint one or more “trading users” traders who make those determinations. For example, in some embodiments, rules may specify that a trader with the highest “trade rating” (e.g., a rating of the user's historic trading performance, e.g., based on internal rate of return or other metrics) of the group (or top two, top half, etc.) may engage in trading on behalf of the group. In some embodiments, rules may specify that all users may trade, or that any user may trade group account assets upon approval of one (or two or another number or a majority) of group members. In some embodiments, a user may propose a trade, and the proposed trade may be electronically communicated to all other group members who may then respond with an approval or rejection of the proposed trade. In some embodiments, all may trade individually.

(6) Any restrictions on trading and the use of funds in the account. For example, a group investment fund may be restricted for use only to trade common and preferred stock, fixed income instruments, derivatives, and/or other investment instruments. In another embodiment, a group “movie outing” fund may be restricted to purchase movie tickets, refreshments, and/or any purchase made from a Cineplex or entertainment venue, or any purchase classified as “entertainment”. In some embodiments, the server may process transactions (e.g., via transfers from an account to a retailer) and determine the type of transaction (e.g., purchase of food) or the type of vendor (e.g., movie vendor, entertainment vendor, etailer, etc.). To facilitate these transactions merchants can register to qualify to receive portfolio assets in exchange for merchandise bundles. Merchants can also create contests where merchandise is available or rewarded for meeting certain performance criteria. In another embodiment, rules may specify whether trades will occur in real time or at the end of day, e.g., for different financial product or trade types. Other rules can govern directing trades to particular exchanges or auction processes. For example, rules may only allow trading among certain qualified groups or through select intermediaries (e.g., intermediaries that are designated in the account, or intermediaries that satisfy pre-determined criteria).

(7) Any rules or procedures for joining new users to the account. For example, the rules may specify that only users in the “class of 2011” list (from gradeschool, high school, or college) may join the account. Or, rules may specify that new users must contribute at least $10 before they can join, and earn the right to redeem and leave the account after 14 days. Or, rules may specify geographic restrictions on users, such as a requirement that a user designate a specific city, state, or country of residence or citizenship. In some embodiments, accounts may be open to all users from all countries, or may be open to all countries but include other restrictions. Other rules can be defined by cultural, religious or social affinity criteria. In another embodiment users can be created through being the recipient of a charitable contribution to introduce those with inadequate resources to the markets for savings and investment. For example, rules may specify that one or more users designated by one or more specific charities (or any charity of a certain type, or an individual or group making a charitable contributions) are automatically qualified to join the account, e.g., with certain privileges (e.g., trading privileges) and other specified rights and responsibilities described herein. In some embodiments, the charity/individual/group may donate funds to the account, e.g., on behalf of the one or more users. In another embodiment, accounts may be created to fund a car purchase for a family member, to fund a sweet sixteen party, wedding, or to receive presents from a celebratory event among others.

(8) Any termination or expiration parameters. In some embodiment, the rules may specify that if the account drops below five accountholders or a certain dollar value, the account automatically liquidates and distributes pro rata proceeds to the remaining users. In some embodiments, rules may specify that the group can vote (e.g., majority vote) to determine when to terminate. In some embodiment, the group may appoint (e.g., via an election by majority vote, or by appointment from a default of elected controller) a “controller” of the account who may determine when to terminate the account. In some embodiments, the “controller” of the account may also change or specify one or more or all of the other rule types described herein.

(9) Any rules concerning how the group can create or modify parameters for the account. In some embodiments, rules may specify that a majority or two-thirds (or other proportion) vote is required to change a termination rule or other rule.

(10) Any rules concerning adding or removing members (e.g., group can establish a majority vote system for adding or expelling members; or only certain members can invite others to join).

(11) Any rules governing display privileges and other disclosures about the group account and the constituent member accounts. For example, specified rules may govern whether one member can see another member's constituent accounts and/or the group account.

(12) Any rules governing the use of logos, avatars or nicknames that represent the group members, and intra-group communications. For example, any rules known in the art to govern online forums (e.g., regarding offensive language, advertising, spam, frequency and quality of communications, governance by administrators, etc.) may apply to such communications.

(13) Any rules determining the members naming of its group team, its mascot, colors or design identification, logo or trademark and forms of compensation therefrom. For example, rules may specify determination by majority vote after a nomination period during which members can submit nominations for a final vote.

It should be appreciated that while “majority vote” and control by a “controller” are described with respect to various rule and decision-making procedures herein, it should be appreciated by those of skill in the art that any political procedure for determining an outcome may be used herein to determine any decision described herein. For example, features such as committees, parliamentary procedure, dictatorial control, pure democracy, oligarchy, electoral college, or other decision algorithm may be used to make decisions.

(14) Any rules governing counterparty transaction rights, selection of broker or exchange, and restrictions relating to affinity associations or group membership, be it personal, gender, age, geographic, social, political or environmental. For example, borrowing and lending can only be done among members of the group and not across groups or some groups may decide to share portfolio assets while another may restrict ownership of assets to that which is individually purchased or sold and track the portfolio for performance measurement only. Other rules may cover the forming of acceptable trading counterparties whereby subexchanges can be formed and subexchange competitions and performance measurements can be made.

(15) Any rules determining league or competitive associations for any ranking combinations or procedures. For example, competitions may be held among particular gender, age groups, or school association (e.g., Howard University vs. Harvard University).

(16) Any rules allowing portfolio managers to join groups allowing for the pooling of assets and/or rearranging portfolio choices, decision making, and investments. For example, different funds or portfolio groups can allow recombinations of assets among one or more groups, funds or portfolios. In some embodiments, this feature may accommodate exchange of assets for diversification purposes.

(17) Any rules governing how a user or group of users may earn or accrue points or other value, e.g., which may be redeemable for money (e.g., account value), goods, services, privileges, or other consideration. For example, if the account's financial performance exceeds a specified parameter (e.g., a rate of return of a specified reference index such as the S&P 500), e.g., over a period of time such as five trading days, then rules may specify that a designated trader responsible for the account's trades has earned a designated number of points, such as 100 points for each percentage point by which the account exceeds the reference metric. Such points may be redeemable for cash from the account, control or other decision-making authority of the account (e.g., control over how to spend the group account's funds, e.g., through a pizza party as opposed to a movie), one or more “extra” votes when voting to make decisions for the account, or prizes donated to or purchased by account funds (e.g., candy bars donated to the account or purchased with account funds by an authorized account spender) or received as rewards from qualified merchants. Other awards may be scholarships offered by educational, charitable or financial institutions.

(18) Any rules governing how to measure a performance, e.g., a financial performance of one or more users or an account (e.g., to measure a rate of return or other performance metric for trading activity by one or more users). For example, rules may specify that an investment account's investment performance shall be measured by internal rate of return, or by performance compared to a specified index (e.g., S&P 500) or another account (e.g., “Investment Account XYZ” created by user A) or peer or competitor.

(19) Any rules governing penalties and enforcement of account rules. For example, in some embodiments, rule infractions may be determined by vote of one or more or a majority of “controlling” users or all account participants. For example, a majority of the group may vote to agree that a specific member of the account broke a trading rule. In such a case sanctions may be imposed, in some embodiments.

(20) Any rules regulating borrowing, lending, and repo transactions. For example, in some embodiments, counterparties may be required to be related to a single group, affinity group, league member, geographic location among others. Rules may specify parameters governing the amounts, types, time limits, authorized persons, and other parameters associated with borrowing account assets, lending account assets, and engaging in repo transactions.

In some embodiments, one or more of the above parameters may be specified, e.g., by one or more users, e.g., by electronically inputting these parameters at an interface electronically coupled to a server during an account specification session. For example, the server may prompt one or more users to enter parameters according to one or more or all of the above. In some embodiments, the rules may be displayed to potential and current accountholders.

For example, in some embodiments, a first user may create a “Friday Night Movie” account and fund it with $10. The first user may then invite six friends to join the account by contributing $10 each. Five of the users may join by funding $10 each. Later, one may cash out (e.g., by transferring his $10 contribution back to his personal account), and another may transfer his $10 portion to another friend's “Friday Night Pizza” account. On the Friday of the movie night, the first user may use the remaining $40 to purchase four movie tickets for a Friday night movie. On Saturday, the account may expire, and any remaining funds may be distributed equally among the remaining four accountholders.

In some embodiments, each user (such as a child, e.g., and their associated participants) may hold a separate account (e.g., with funds that are never technically commingled with another child's account), but there may be a “group portfolio” account comprising a plurality of individual constituent accounts. For example, multiple children may link their individual account to a portfolio of accounts in order to share in the profits (and losses) of the portfolio, e.g., on a pro rata basis. Accordingly, a first child may have $20 worth of a share of Google (e.g., as measured by current market value/trading price of the $20 instrument or as measured by the fractional interest in the Google share times the current market value/trading price of an actual Google share) in a first account and a second child may have $100 worth of a share of Apple in a second account, and they may pool their accounts into a profit-sharing portfolio. They may agree to split the gains (and losses) in portfolio value based on their pro rata share of the portfolio as measured by the market value of their own investments at the time of joining the portfolio. For example, the two children may agree to a 20/80 split, e.g., 20% for the first child and 80% for the second child, if the second child's contribution has four times the market value of the first child's contribution (as measured at the time of contribution). If the Apple share decreases in value but the Google share dramatically increases in value such that the first account decreases by $50 while the second account increases by $150, then the two accounts would share in the net $100 gain according to their 20/80 split in the portfolio. The children may agree that the gain (or loss) may be allocated to the first and second accounts based on their pro rata contributions at some designated future time, such as a time when one or the other child decides to cash out or otherwise leave the portfolio.

In some embodiments, other users (such as children, e.g., and their associated participants) may join and share in the portfolio according to their pro rata contribution at the time of joining. The children may agree to rules and policies (e.g., as set forth above in 1-10). When the first child decides to leave the portfolio, the first account is credited (or debited) so that it holds the proper amount of gain (or loss). Depending on the circumstances of such departure, the system may trigger the sale of one or more shares in the child accounts, transfer cash or shares between different child accounts, or otherwise rebalance and redistribute funds among accounts so that the departing child account holds the correct value and the remaining portfolio contains the correct value. In some embodiments, a departing child account may trigger a rebalancing (e.g., involving transfers and/or trades between of one or more child accounts) so that all child accounts contain the correct amount. However, to minimize transaction costs, some embodiments may allow child accounts to deviate from their pro rata market share, and rebalance to the pro rata share only upon such child's departure. The portfolio and/or the constituent accounts may be charged one or more fees, e.g., a fee for participating in the portfolio account, a trading/brokerage fee, or other fee.

In some embodiments, the system may “normalize” the constituent accounts by causing internal transfers between accounts so that each account has the same balance of assets as the other. For example, the total group portfolio contains 20 DDR shares of Google and 10 DDR shares of Apple, then the system can cause transfers between the constituent accounts so that each has Google and Apple DDR shares (or fractional dollar amounts worth of shares) in a ratio of 2 to 1. This “normalization” process may occur at a time an account is joined to the portfolio, when an account leaves the portfolio, after a certain threshold number of users have joined an account, when an account is closed to other users, or another time such as daily or monthly.

Dollar Depository Receipts (“DDRs”) and Fractional Ownership

“Dollar Depository Receipt” (or “DDR”) means a fixed dollar amount of a financial instrument, commodity, portfolio, mutual fund, derivative or physical asset, e.g., as described herein and an asset of value or tradable entity.

In some embodiments, user and group accounts may “own” dollar amounts of sub-shares of stock, that equate to 1/50 of a share of Google stock (i.e., a $10 portion of a $500 share of Google stock). For instance, a broker may divide a $500 share of Google stock into 50 subparts, and sell rights in each sub-part to users for $10 each (or 500 subparts for $1 each). (The broker may keep title to the share.) The sub-shares may be bought from and sold to a broker, e.g., for a price that is tied to the market price or through an exchange. (In some embodiments, the broker may charge a fee or price premium for offering this service or fees may be paid by advertisers, charitable organizations, exchanges or sponsors or the child's parents.) The broker tracks the “ownership” of the resulting dollar amount of sub-shares, number of DDRs among the different users and user-created accounts. In some embodiments, the DDRs may be traded between users and transferred between accounts. The system tracks any transfers and reports them to the title-holding broker or clearinghouse or exchange, so that the broker can track who owns the resulting fractional shares. The broker may charge users a small fee for enabling users to own DDRs.

In some embodiments, what may be created may comprise a variable exchange rate for DDR conversion and a fixed value sales price for a variable amount of an asset. The DDR position may carry the original exchange rate. This may keep the price constant but may change the size of the bundle of goods for purchase or sale. This type of DDR may conform to the idea that some people like to buy and sell a fixed dollar amount of an item (e.g., “$20 worth of Google shares”) rather than a fixed quantity (e.g., one, one hundred, or fractional amounts like 0.2 shares of a security). This is especially relevant to younger individuals who are first introduced to monetary units and budgeting their allowance expenditures, who may have an easier time understanding a trade for “$10 of Google shares” than a trade for “0.16823 shares of Google”.

The actual title of the underlying financial instrument (e.g., share of stock) and the fractional interests therein may be held or owned by one or more parties, such as the end user, broker, issuing party or government (e.g., Apple may hold the Apple shares), an account provider (e.g., a bank providing user and group accounts as described herein), a group or user account, or one or more individual users. In some embodiments, one of these entities (such as the broker or account provider) may hold title to the sub-shares or whole financial instrument, while one or more rights in the whole or fractional interest may be held by an individual user or group. DDRs may be created to be bearer instruments, paper certificates, minted coins, script or book entry instruments. In addition, users may freely trade their interests in the DDRs that represent an equivalent amount of sub-shares in the stock or financial instrument, even though technically a broker, trust, exchange or bank maintains title to the underlying financial instrument.

In some embodiments, the broker can issue $1 (or $10) “sub-shares” of a stock (such as Google) on different days (e.g., every day, week, month, or based on a triggering event). For example, if Google is trading at 2:00 pm on May 1, 2012 for $525.00, the broker can issue 525 $1 interests of Google (that are dated May 1, 2012) at 2 pm that day (or another time that day) that are each worth 1/525 of a Google share. On the day of issuance, the $1 sub-share may be redeemable for $1 (e.g., minus transaction or handling fees). A week later, on May 8, 2012, Google may be trading for $450.00, e.g., at 11:00 am. At 11:00 am on May 8, 2012 (or another time that day), the broker may issue 450 $1 Google DDRs (dated May 8, 2012), each having a value of 1/450 of a Google share. Users may be buy, sell, and trade the DDRs. The DDR values may be tracked by the server or computer systems that drive these processes.

In some embodiments, the system may enable users to request subshares for stocks and other financial instruments for which subshares are not offered. For example, a broker may automatically start issuing subshares for a particular security (e.g., subshares worth $1 or $10 on the day of issuance, or redeemable for a designated fraction of the share) once enough different users request the subshares. For example, users may vote on securities for offering subshares, and may pre-commit to purchasing a number of subshares. In some embodiments, when the subshare market for the selected security is created, the “pre-commited” users may automatically purchase the requested number of fractional shares.

An exemplary DDR may comprise a face value currency amount of a financial instrument, such as a “$10 Google DDR” created on Jan. 1, 2012. A financial intermediary may create the DDRs on Jan. 1, 2012, e.g., by purchasing one share of Google stock and issuing fractional ownership interests in the Google share as DDRs. With a Google price of $500 per share at the close of business on the date of creation, 50 $10 Google DDRs are created that can convert to one share of Google stock with an exchange rate of 50:1. Then when the financial intermediary sells two $10 Google DDRs to a buyer in exchange for $20 when the price of Google is 5500 per share, the buyer's two $10 Google DDRs represent a claim on 0.04 shares of Google stock, and the financial intermediary may create an ownership transfer entry in those shares.

In some embodiments, the $10 Google DDR may always be priced at $10 but will represent an interest in a variable number of shares depending on the market exchange rate of Google shares for the $10 Google DDRs. For example if the price of Google drops to $400 per share then the new exchange rate is 40:1. The client's original purchase of two $10 Google DDRs represented 0.04 shares of Google at the exchange rate of 50:1. At the lower price of $400 per share two $10 Google DDRs represent 0.05 Google shares or 0.025 shares per $10 Google DDR whereas the original 0.04 shares or 0.02 shares per $10 Google DDR at the new price would have a value of $16 reflecting the drop in price from 5500 to $400 per share. To balance out the portfolio of the original client at the new price of $400 but still holding two $10 Google DDRs means that he has an offsetting deficit of $4 (or put another way, he is 0.01 Google shares short at the new price and exchange rate). So instead of having 0.05 Google shares at the new lower price the original client has a claim on only 0.04 Google shares. If the original client were to sell his two $10 Google shares on the open market the $20 transaction would be split into a client credit of $16, and the remaining 4 would be used to purchase 0.01 shares of Google to match the new exchange rate of 40:1; accordingly, 0.04 shares from the original transaction and 0.01 new shares would give the new owner two 10 Google DDRs with a claim on 0.05 Google shares.

The system may create, issue, track, redeem, and enable secondary trading of DDRs. Due to the constantly changing “exchange rate” of DDRs in some embodiments, small fractional amounts may be generated. For example, a $20 DDR of Google stock issued based on a Google stock value of $400.00 may be valued at $20.001 on a day when Google is trading at $400.02. The system may address very small fractional portions of a share or a penny (e.g., fractional amounts of a financial instrument such as 0.00000001 shares of IBM stock, or currency amounts like 0.1 cents) in a variety of ways. In some embodiments, such tiny fractional amounts may be pooled into an account like a “penny jar” at a convenience store, wherein a transaction or user may take from the pool when needed to “round up” to the next highest fractional unit or amount (e.g., to round up to ⅔ of a share from 0.6666 shares, or to $20.00 from $19.999), and the system may transfer such tiny fractional amounts into the “penny jar” account when circumstances warrant (e.g., when the system or broker redeems a user's DDR worth $20.001 by paying or crediting the user with $20.00). In other embodiments, the system or relevant broker may simply keep the tiny fractional amounts, and amounts may be “rounded down” against users as part of a fee, such as a brokering or transaction fee.

In some embodiments, tiny fractional amounts may be tracked and allocated precisely, such that a user redeeming $20.001 will be credited the full amount of $20.001 inside the system. Fractional amounts may be addressed another way (e.g., as described herein) when users leave the system, e.g., when users close all their accounts and cash out completely.

In some embodiments, limits may be set on the extent to which tiny fractional amounts are tracked or allocated. For example, the system may set a limit of $0.0001 as the smallest amount that will tracked and allocated, wherein amounts below this will be “rounded down” or otherwise addressed as described herein.

In some embodiments, the tiny fractional amounts that are “rounded down” or otherwise lost due to their tiny size may be stored in a special account such as a prize account. The prize account could be awarded in whole or part as compensation or a prize or award. For example, it could be awarded to the best player or investor or awarded to the worst player.

In some embodiments, the tiny fractional amounts may be addressed in one or more of the ways described herein. For example, fractional amounts above a specified level of precision (e.g., $0.0001) may be tracked and allocated precisely. Amounts between this threshold and a lower threshold (e.g., amounts between $0.0001 and 0.00001) may be allocated into a prize pool. And amounts below the lowest threshold may be absorbed as transaction fees. In other embodiments, tiny fractional amounts of different types or in different contexts may be handled differently. For example, when cash amounts are redeemed for actual paper dollars and metal coins, fractional amounts may be rounded down and addressed in any manner described herein. When a trade of one financial instrument for another financial instrument occurs, tiny fractional amounts may be tracked and allocated precisely according to the trade. When a user buys a financial instrument from another user by electronically exchanging the relevant cash amount to the other user, the amount paid may comprise a tiny fractional amount (e.g., up to a predetermined number of significant digits, and the remainder may be addressed as described herein).

In some embodiments the group may decide to allow the trading of the portfolio created by the group. In this embodiment a new financial instrument can be created similar to an ETF (“Exchange Traded Fund”) or DTF (“Dealer Traded Fund”). These DTFs likewise can be traded among groups or within leagues.

Limited Risk Account

A limited risk account (“LRA”) may comprise an investment account with a set dollar limit for original deposit, e.g., $100. It is an account that can be created online from the information available in a social network account or through the access of an App. The account can be funded from various sources ranging from banks, cash, PayPal, credit cards, or credit from gaming sites, electronic transfers, debt instruments, labor arrangements, or member and group credits, IRAs and other retirement accounts, merchant sponsors, scholarships, education grants or charitable contributions.

A LRA may also comprise an account that has a restricted age limit, parental or educational approval, and/or specified rules with regard to account information. Rules may govern disclosure of account-related information, e.g., to educational institutions, parents, friends, merchant sponsors, governmental authorities who have concerns with regard to trading, money laundering or terrorist activities. An LRA may also have exemptions from regulatory bodies with regard to account information, trading limitations, anti-money laundering and fiduciary requirements.

Genomic Trading

In some embodiments, the system can track user and group account and trading activity. Based on this activity, the system can determine user and group preferences (e.g., in a manner similar to Netflix for movies and Pandora for music). The system may make recommendations (e.g., recommend a stock or rate a stock based on a user's or group's preferences or trading history), and suggest stocks to buy or sell, e.g., for diversification or to better hedge an existing portfolio. The system may disclose the preferences and recommendations—as well as account information—of one user or group to the user and group, and may also disclose the information to other individuals and groups. For example, a user may request recommendation information (or account information) from another user, or the group may allow only “friends” of a user to view that users recommendations, ratings, and account info.

In some embodiments, the server may process a Genomic Trading Algorithm (“GTA”) that may determine information about trading interests, preferences, or history of one or more users or groups. Based on such information, the server may present to one or more members of the group one or more items of interest that may represent financial instruments, e.g., with similar characteristics or instruments that represent one or more characteristics of a target portfolio, such as a diversification for the selected group portfolio or financial instruments that share similar features to others already in an individual's portfolio. The algorithm can provide items of interest that have been either similar or dissimilar in regard to performance, most recent or popular items selected, or that provide diversification, or selected by characteristics related to demographic or select cohort groups, e.g., those in the youngest age group, school affiliation, hot lists of gadgets, entertainment, sports, and fashion and/or geographic location.

In some embodiments, the server may enable one or more users or groups to explicitly identify one or more trading preferences, such as preferences (e.g., preferences for or against) relating to: specific financial instruments (e.g., prefer Apple stock and Google bonds and disfavor IBM stock), types of financial instruments (e.g., prefer blue chip stocks, disfavor foreign exchange and mutual funds), trading strategies, timing of trades, types of orders (e.g., prefer market on close orders and disfavor good until cancelled orders, etc.), preferred and/or disfavored counterparties (e.g., “trade with A, B, and C individuals and D, E, and F Groups and any group that contains G individual but not L, M, and N individuals or P, Q, and R groups or any group that contains S”), preferred and disfavored hedging strategies, quantity preferences and limits (e.g., prefer purchase amounts around $5, and purchase no more than $10 of any one stock per day), and any other preferences.

In some embodiments, the Genomic Trading Algorithm may recommend hot trading stocks and individuals and/or give volatility warnings or tag losers by time or identify conflicting interests, e.g., if diversification is desired by the group create a metric or graph to show undue concentration or correlations.

In some embodiments, the server may enable one or more users to make trades recommended by the Genomic Trading Algorithm. For example, a prompt may query a user, group, user designated by a group, or multiple users whether such user/users wish to make a trade or group of trades recommended by the Genomic Trading Algorithm.

For example, the Genomic Trading Algorithm may recommend that Group Portfolio #6 should purchase 0.2 shares of IBM stock and sell 0.6 shares of Exxon in response to a group goal. A prompt may query one or more users in Group Portfolio #6 who are authorized to make trades for Group Portfolio #6 whether they wish to make one or more of the recommended trades. The prompt may be one or more communications such as an SMS text message, email, pop-up window, telephone voice prompt, icon or message in the account triggered upon account login, or other communication. The user(s) may respond to the communication, e.g., by indicating “yes” (e.g., “conduct recommended trade”), “no” (e.g., “do not conduct recommended trade”), “cancel”, “defer query” (e.g., to a later time), “amend recommendation,” “recommend a different trade,” etc. The response may be via reply email, text, selecting “yes” or “OK” on a webpage, swiping a screen, voice command, etc.

In some embodiments, users may enable the server to make one or more types of trades recommended by the Genomic Trading Algorithm automatically, without requiring a response from the user. For example, a user may configure an account to make all Genomic Trading-recommended trades, e.g., all recommended trades or trades of a specific type (e.g., all trades that are each less than $5 in traded value, or all trades involving stocks or specifically identified bonds), e.g., without requiring the user to confirm the recommended trade. In some embodiments, the user may configure the server to only execute such trades only after notifying the user and waiting a user-specified period of time for a response from the user. In some embodiments, the server may communicate all trades to users, e.g., via electronic account status updates, e.g., before and after such trade.

Borrowing, Lending, and REPO Transactions

In some embodiments, the system may enable two or more users or groups to engage in sale and repurchase (“repo”) transactions by buying and selling repurchase agreements. A repurchase agreement, also known as a repo or sale and repurchase agreement, is the sale of securities together with an agreement for the seller to buy back the securities at a later date. The repurchase price should be greater than the original sale price, the difference effectively representing interest, sometimes called the repo rate. The party that originally buys the securities effectively acts as a lender. The original seller can effectively act as a borrower, using their security as collateral for a secured cash loan at a fixed rate of interest. Thus borrowing and lending among participants can be accommodated.

A repo is equivalent to a spot sale combined with a forward contract. The spot sale results in transfer of money to the borrower in exchange for legal transfer of the security to the lender, while the forward contract ensures repayment of the loan to the lender and return of the collateral of the borrower. The difference between the forward price and the spot price may effectively be the interest on the loan, while the settlement date of the forward contract may effectively be the maturity date of the loan.

In some embodiments, the system may facilitate repo transactions so that the initial and final transfers occur automatically. For example, a first user and second user may configure a repo transaction wherein the first user “loans” a DDR of Apple stock (market valued at $10) to the second user for one week in exchange for the second user “loaning” the first user $10. At a user interface, the first and second user may define the repo contract by specifying the beginning and end dates, the instruments and/or cash or other consideration to be exchanged, and any “interest” to be paid (e.g., by one user in exchange for the “loan” of cash). As understood by those of skill in the art, two separate users can configure a single contract in any variety of manners, e.g., via a common GUI that requires each user to separately approve the contract once configured, or via one user proposing various contract terms and the other user accepting them. At the beginning of the repo period, the system may automatically transfer the DDR of Apple stock from the first user's account to the second user's account (or to a special repo or escrow holding account), and automatically transfer $10 from the second user's account to the first user's account. At the end of the one week repo period, the system may automatically transfer the DDR and $10 back to the original owners and also transfer the defined “interest payment” from the first user's account to the second user's account. In effect, the second user may effectively “loan” the first user $10 to go to the movies, wherein the loan is secured by the first user's Apple DDR, and the interest paid by the second user is effectively interest paid for the loan. The interest can be represented by transfer of a subset of one or more sub-shares of the borrowers' portfolio to the lender.

The parties may also specify rules concerning breach, e.g., in the event one party (such as the cash borrowing party) cannot repay the other party at the end of the repo period. Such rules may include, for example: lien imposed against defaulting party until debt is paid, e.g., with interest of specified rate such as 5% annually (e.g., any cash or other assets that appear in the defaulting user's account or other accounts may be automatically transferred to the wronged party until the wronged party is made whole); suspension of one or more accounts or privileges of defaulting party, including accounts that enable social networking activity such as posting pictures, etc.; point penalties; and other rules.

The “interest” may comprise cash, financial instruments, services, or other consideration, such as points, rights, privileges, and one or more promises of future goods and/or services. For example, user A and user B may enter into a repo transaction wherein user A (or group A) transfers cash to user B (or group B) and user B transfers a portfolio or sub-set of a portfolio (one or more financial instruments, cash, and/or other assets in an account) to user A, e.g., for a defined period of time such as one month. At the end of the period, user A and user B may “trade back” their respective assets, and user B may additionally pay user A “interest” in the form of points, cash, an “IOU,” a promise to do a future favor for B or on behalf of B, a pack of gum, or other consideration. In some embodiments, rules may specify that user A is not “released” from the “interest” requirement until user A releases user B, e.g., by clicking an appropriate button on a user interface, e.g., that confirms “user B paid me non-cash consideration that satisfies the repo requirement in full.”

In some embodiments, the repo transaction may provide rights to trade to the user temporarily holding the financial instrument(s) (e.g., the party temporarily holding a DDR). For example, in the example above, user A may make trades using the portfolio. Accordingly, the portfolio may change during the repo period. At the end of the repo period, the “borrowed” portfolio may comprise different instrument(s) and/or cash, and such cash and securities may be provided back to user B (e.g., instead of the original portfolio, which has changed) or he can substitute another asset of value resulting in a substitution of collateral without having the trading rights. In some embodiments, the right to engage in trading with the other party's assets may represent the “interest” or repo rate. In other words, instead of charging cash interest, the “charge” could be the right to practice trading with the other party's securities.

In some embodiments, the ultimate owner of the financial instrument(s) (here, user A) may retain the right to trade during the repo period. Accordingly, even though the first user may not technically hold the DDR during the repo period, user A may retain the right to trade the Apple DDR for a Google DDR plus cash during the repo period, e.g., via the escrow or repo account (or via special repo-related privileges in user B's account). In this case, instead of receiving back an Apple DDR at the end of the repo period, user A would receive the Google DDR plus cash.

In some embodiments, the parties may define parameters that govern permissible trading behaviors during the repo period (e.g., no derivatives trading) and how to handle any losses or gains (e.g., as a result of trades, or for a given financial instrument or the portfolio as a whole). For example, when defining the repo contract terms, the parties may specify that the party engaging in trading behavior may keep a portion of gains above a certain amount (e.g., anything above 10% gain), but will be liable for any loss below another threshold (e.g., below 15% loss). Notably, the parameters may be favored towards the trader to account for the “interest” due to the trader. Or, if losses are incurred, the losses may offset in whole or part (or more) interest charges inherent in the repo transaction.

Notably, in the above example, the Apple DDR may have risen or declined in value during the repo period (and thus may have a market value that is more or less than $10 at the end of the repo period), and that risk would normally be borne by the ultimate owner of the DDR, the first user.

Reviews and User-Created Content

In some embodiments, users can store, email, tweet, post, or otherwise associate information with one or more financial instruments, companies, people (such as users and/or non-users), products, services, websites, events, media content (e.g., audio content, music, photographs, video content, website, etc), memes (e.g., words or phrases, symbols, etc.), styles (e.g., fashion styles, clothing combinations, make-up styles), trends, and other concepts. The information associated by the user may comprise a note, comment, review (e.g., essay review and/or a review on a point or star scale along one or more criteria), thought or opinion (e.g., “like,” “dislike,” “neutral,” “want to buy,” “do not want to buy,” “no opinion,” “funny,” “not funny,” “watch this,” “interesting,” or other concept (such as media content, e.g., an audio or video file, e.g., created or uploaded by a user), such as by selecting a “want to buy” button or indicator associated with the concept). Such information may be stored, e.g., in the associating user's profile, or in a file associated with the relevant concept (e.g., stored on a review site that stores multiple user reviews). In some embodiments the system may identify users (e.g., by requiring login or checking a cookie), e.g., to identify information about a user who associates information with a concept. For example, users may be required to login to the system before submitting positive or negative reviews about a particular product or other concept, and thereby prevent a single user or group from overly changing a net review score concerning an item. In some embodiments, content associated by a particular user may be kept private to the user (e.g., stored only in a user's private profile), disclosed to one or more people (e.g., one or more specific users or groups, e.g., a user's designated “friends,” or the general public). Associated content (e.g., reviews and likes) may be aggregated, e.g., for an aggregate review or “want to buy” score, or a “want to create” score for the origination of new DDRs or a score indicating a measured interest of the entity to undertake an IPO.

For example, user posts, reviews, “want to buys,” etc. may be stored, tracked, and aggregated in a manner similar to the systems and methods used by Facebook, Amazon.com, Twitter, and other websites. The system may enable members' activities to cause the generation and sending of automatic Twitter, Facebook, or other websites messages. For example, a user, group of users (e.g., in a person's profile or friends list), or the public at large may be notified by the system (e.g., via email or news flash/post), e.g., when a DDR is purchased.

The system may enable users to associate information with content and concepts. In some embodiments, concepts may be rated, e.g., by users and/or the system. For example, users may review and rate content (e.g., media content such as video files; websites, e.g., identified by a link or web address) provided or identified by other users. For example, users may upload or otherwise identify content such as a video (e.g., to the system, or to youtube or other private or public media-sharing site). Users may view and rate the identified content.

For example, a user may post a title and/or link to a specific video file, such as an instructional video lesson (e.g., from Khan Academy) on a math concept created by another person or source. Users may view and rate the video, e.g., using numerical and prose commentary and reviews, e.g., according to a variety of criteria such as teaching effectiveness, grade level, difficulty, excitement, content area (algebra, calculus, trigonometry, English, history, economics, handwriting, foreign language, etc.), number of mistakes, recommendations for changing the video, audio quality, number of concepts discussed, etc. User may also provide comments concerning the source, e.g., creator of the video. In some embodiments, users who view instructional videos may also take a short quiz or test on the concept, and the test results may be aggregated for a particular user or a number of users to assess one or more rating categories of such video, such as the video's clarity, length, teaching effectiveness, content length and/or quality, grade/reading/comprehension level (such as easy, moderate, or difficult), “like” or “recommended” (or “don't like” or “don't recommend”), overall rating (e.g., on a scale of 1-10), and other parameters. Subsequent tests on users (e.g., for other instructional videos or the same video) may be used to assess the user's mastery of earlier-viewed lessons.

Tutorials.

In some embodiments, the system may provide tutorials concerning one or more topics, including one or more topics related to financial instruments, investing, and other business concepts. For example, the system may provide a tutorial describing the difference between a “call” and a “put”. The tutorials may comprise any type of tutorial and may comprise audio, text, pictures and/or video. The tutorials may be submitted by professionals, e.g., advertising partners who advertise to users via the server, and also may be provided by users themselves. In another embodiment contests may be conducted relating to the best or ranked videos, tutorials, graphics, illustrations or explanations with regard to topics of interest or germane to the activities of the members or groups.

In some embodiments, tutorials may be submitted and displayed in a manner similar to YouTube.com and/or Wikipedia.com. In some embodiments, discussions and response tutorials (or other audio or video) may be provided, e.g., by the system, professionals, or users in response to another tutorial or response. For example, in response to a confusing tutorial by a professional manager concerning the investment concept of “alpha,” a user may post a response tutorial that the user may deem easier to understand. Users may rate or “like” specific tutorials and content, e.g., in a manner similar to the rating systems used by amazon.com, Netflix.com, ebay.com, and YouTube.com. The system may track rating information and the source of the rating information. Based on ratings and sources, the system may provide customized ratings for each user, e.g., based on the user's similarity to other raters. For example, while one tutorial on “hedging” may have the highest global ranking (e.g., based on a numerical 1-10 rating by each rating user), another tutorial on hedging may have a higher ranking among 17 year olds (or users who purchase options), and yet another may have a higher ranking among 12 year olds (or among users who tend to purchase stocks). The system may recommend the second and third tutorials to their respective age groups, e.g., by explicitly displaying a recommendation indicia next to the video or displaying it in a higher ranked position than other tutorials, and/or the system may weight user rankings according to the ranking users' similarity to the viewing user.

In some embodiments, one or more users or user groups may vote on concepts, e.g., videos, for a specific function or purpose. Votes may be counted or cast based on any number of voting methodologies, e.g., one-user-one-vote, point allocation (e.g., each user has 1000 points to allocate to candidates), an aggregate ranking system (e.g., each user ranks the user's top four candidates), etc. For example, users may vote for a specific Khan Academy video (or music video) to be highlighted or recommended (e.g., by the system) to one or more other users. In another embodiment, users may vote for a person (e.g., Warren Buffett or Barack Obama) to be invited to speak to one or more groups of users, e.g., concerning a topic such as investing. In some embodiments, a vote may be conducted to identify media content that will be more fully developed, e.g., developing a short video commercial into a full-budget fully produced commercial. In another embodiment corporate entities that make up individual or group portfolios may present materials that explain their corporate mission or describe the products that they sell, and may also provide a list of commercials for viewing, listening or reading. In some embodiments, user information and rating information may be used to selectively target the advertisements, e.g., to users most likely to have an interest in the advertised product, service, brand, or company. The advertisements may be targeted based on trading activity by the user or a group account associated with the user (e.g., which companies' stock has been purchased or sold by the user or group account). For example, a competitor of a company may target an ad to users who have recently sold stock in the company. The system may incorporate algorithms (e.g., such as algorithms used by Google and other companies to target ads based on user behavior) to select an ad from a pool of ads to display to a user.

For example, a browser toolbar may enable a user to select a concept (e.g., a product offered for sale, or a word appearing on a website), e.g., by clicking, mousing over, or otherwise selecting a portion of a display associated with the concept (e.g., by highlighting the relevant word appearing on the website). Once the concept is selected, the system may enable the user to associate information, such as an opinion, “want to buy,” or other concept or content. In some embodiments, users may associate information with a concept in a single step, e.g., by simply checking a “want to buy” (or other concept) box or other indicia next to a particular product, service, or financial instrument, or enter an appropriate input (e.g., right-click on a particular product to indicate “want to buy”).

The system may track and aggregate the information associated with the various concepts. For example, the system may track which products, services, and financial instruments receive “want to buy” associations from users. The system may process the data and transmit information or take other action based on the tracked and aggregated data. For example, if the number of users (e.g., total users or users of a particular type, such as users within a certain age or geographic region) who “like” or “want to buy” a particular financial instrument exceeds a predetermined threshold (such as 100 or 1000), the system may cause a DDR to be created and offered for that financial instrument.

Based on user information and/or other information, the system may determine information about one or more users, products, services, companies, and financial instruments. For example, the system may determine one or more “hot” or trending products, services, companies, financial instruments, and other concepts based on information determined to be associated with such concepts, e.g., based on a number of users “liking” or “wanting to buy,” positive reviews, and/or mentions by users. For example, the system may determine the frequency that users (and/or others) mention, and analyze how the frequency changes over time. For example, the system may identify a particular company or other concept as “hot” or “trending” if the frequency of mentions or new “likes” increases above a particular threshold. The system may rank such concepts according to various criteria (e.g., “hot,” “want to buy,” “dislike,” etc.), and may publish such rankings. In some embodiments, the system may determine such information in a manner similar to that used for Yahoo.com's “buzz index.”

some embodiments, the system may charge a fee (such as a premium subscription fee) for information and content such as rankings for concepts, financial advice (e.g., which stocks the system predicts to increase or decrease in value). Companies may also be charged for access to member created data and preferences. Companies may also be charged a fee when the system causes one of their ads to be output to a user targeted based on user information, criteria, trading behavior, etc.

The system may also track such data for market research purposes, e.g., to forecast the supply, demand, price, or popularity of a particular product, service, financial instrument, company, or other concept. For example, in the above example, when the number of users who “want to buy” exceeds a predetermined threshold, the system may purchase quantities of the financial instrument or derivative financial instruments thereon (e.g., options to buy the financial instrument) based on a prediction that the price of the financial instrument will rise.

The system may also record and track lists of portfolio performance and contest winners. This data may be made available to registered or unregistered educational institutions and future employers. Registration may entail fees that can be distributed to member groups or to the broker or exchange.

In some embodiments, portfolios of users and user groups can compete against other portfolios from other users and groups. Competitions may comprise tutorials or performance of biggest gains over a certain period, most diversified portfolio, portfolio that best satisfies a defined system metric, best sterling ratio, least drawdown, least volatile, best day trader, or best long term investment among others and among friends categories, e.g., age, gender, affiliation or geography. For example, users may compete to create the best or highest-rated content (e.g., tutorial or product review) among their group (e.g., 14-year olds in Montana) or across the system. Users who place or win the competition (e.g., among specific groups or across the system) may win points, cash, DDRs, other financial instruments, or other rights, privileges, or benefits. For example, winning users may earn the right to select which person or company is invited to present an online tutorial on a given topic. For example, a winning user who submits the “best” tutorial on “repurchase agreements” may win the right to select that Warren Buffett be invited to conduct an online training session on investment strategies. Winning users may be selected by the system to band together an advisory council, a college of cardinals or all pro team. Sponsors may reward such winning users.

Competitions may be judged by an expert panel or by peer reviews or a court selected by members of groups.

Selected or system generated critics may comment on either winners or losers. Recommendations for subsequent contests may be generated and distributed privately or made available for more public viewing or only those who participate in the contests.

In some embodiments, the system may store and monitor user data, including user communications, transactions, trading activity, contest activity, social networking behavior (adding and subtracting friends, posting pictures, tagging pictures), frequency of activity, click through rate of advertisements, web surfing activity (e.g., which may be monitored by cookies and/or bots), and/or any other behavior that touches the server or any other system or software component.

In some embodiments, the system may process such data to identify types of users, such as “star traders,” “connectors,” “mavens,” thought leaders, trend setters, and other types of users. For example, the system may process historical trading information to determine one or more traders who consistently perform better, e.g., as compared to other users, an index, or another metric (e.g., a benchmark index specified by such user). Such users may be designated as “star traders”, and such users may be designated as “star traders” to the public or to one or two or more degrees of separation from their social network.

In some embodiments, the system may publish a “trade ranking” ladder of one or more users (e.g., in a particular group, collection of groups, geographic region, age group, social network, or system-wide) designating the relative rank of such users according to one or more trading performance metrics, such as rate of return. The ladder could effectively rank the trading performance of such users, e.g., based on how well the traders achieved intended investment objectives or consistently outperformed a benchmark or the market or other users. For example, a user who “day trades” on behalf of a group account and consistently outperforms the S&P 500 may earn a “star trader” designation and a #2 ranking within the user's social network (e.g., the group consisting of the user and other users he designates as “friends”).

In some embodiments, the system may identify “hot” or trending products, services, persons, brands, or other ideas or trends. For example, the system may monitor user communications and trading activity to determine an increased interest in a particular smartphone or basketball team or player among users of a certain type (e.g., users of a certain age or age range and/or from a particular geographical area and/or having a particular type of user history, e.g., a history of buying a specific stock or type of stock or history of visiting a particular website or making a particular type of remark to friends within two degrees of separation from their friend network).

In some embodiments, the system may identify one or more users as “connectors” who (1) have a relatively large number of friends, (2) engage in two-way communication with a relatively large number of different people, (3) have a relatively large number of friends of different types (e.g., of different geographic regions, schools, ages, sports, interests) who are not friends with one another, (4) have a relatively large number of group affiliations, and/or (5) have other characteristics that indicate an ability to connect different people together, e.g., by facilitating new friendship connections on the social network.

In some embodiments, the system may identify “mavens” who frequently communicate about sales, deals, and other offers and/or are frequently consulted concerning deals or other financial transactions.

In some embodiments, the system may identify leaders, thought leaders, and/or trend setters who (1) tend to engage in behavior, make purchases or trades, adopt identifiable behaviors, use certain words or slang, discuss certain brands, publish communications concerning certain brands, products, teams, people, or other ideas or things, before most other users; and/or (2) tend to be a cause of other users engaging in such behaviors, purchases, word usages, etc.

In some embodiments, the system may determine “hot” products, trends, brands, etc., e.g., among one or more groups or geographies or the entire system at large, and publish such information, e.g., to one or more groups, geographies, etc. For example, the system may publish “what's trending” or “what's hot” based on user activity. In some embodiments, the system may publish or determine such information based exclusively on, or weighted on, information about users of a specific type (e.g., trend setters or thought leaders), e.g., as compared to typical users. Accordingly, the system may determine that the latest shoe from a given brand is “hot” based on communications or activity of identified trend setters, while another model from another brand that is more popular in communications at large among the same group or system may not be designated as “hot.” Companies associated with “hot” may be recommended for trading to select groups.

For example, the system may determine what stocks or products are popular among specific demographics, such as 17-year old girls, or high school students in the northeast who regularly use four-syllable words and play at least two sports.

Group Constructed Portfolio Funds.

In some embodiments, a group may create a portfolio fund, e.g., by constructing a portfolio within an account. Different authorized users of the account may select financial instruments for the fund, which may be purchased with cash or other assets in the account (which may be contributed by users). Users within a group may recommend or determine what securities certain members of the group should buy or sell. For example, vegetarian members may be restricted from buying companies associated with meat products or genetically modified foods. Also, the group may enable other users to buy into the account in exchange for a percentage ownership of the fund (or in some embodiments, the account may issue shares). For example, a new user may contribute $30, and the account managers may use the $30 to purchase $30 of assets mirroring or otherwise representing or contributing to the fund.

In some embodiments, one group fund or portfolio could be combined with all or a portion of another group portfolio fund. For example, two accounts could be combined or partially combined (e.g., into a third account), and the different accountholders could receive shares or ownership percentages based on their original ownership in the underlying accounts.

Graphic User Interface and System-User Communications

In some embodiments, users may communicate with other users, brokers, third parties, and the system via a user interface at a processing device such as a computer, smartphone, or other computing device, e.g., in a manner similar to how users use a desktop computer or iPhone 5 to interact with Facebook.com, Schwab.com, Citibank.com, and YouTube.com. The user interface may have audio and video communication capabilities.

In some embodiments, information about a user and/or group account may be provided in the user interface. For example, a user interface may display a group portfolio ticker. The ticker may be accessed by touching the group's logo on a display device. Tapping a screen or accessing an audio command may allow the screen to display other attributes of the portfolio, e.g., three swipes of the screen as in roman numeral III will display the ticker or gain or loss of the top three holdings in the portfolio. Similarly, a double tap on the logo may cause the system to display the set of all logos of firms in the display. In another embodiment, different swipes of the active member's screen will generate different views or data sets associated with the member's or group's investments. The LOGO app may also be accessed to generate potential portfolio investments or to create sample portfolios for tracking and comparison purposes. Logos of securities can also be obtained from other databases and used for portfolio selection purposes. Screen swipes can be expanded to bond screens. Swiping an X may bring up quotes on the 10 year treasury, II, the two year, etc.

In some embodiments, account login may require account credentials such as a user ID, password, fingerprint or other biometric identification, second device verification (e.g., authorization code text sent to mobile phone prior to login), and/or other authentication.

Parental Controls.

In some embodiments, products, services, companies, financial instruments, content, and other concepts may have parental controls. For example, a parent may specify a rule that a child user must obtain parental consent in order to engage in specific types of activity or transactions. For example, if a child user requests to purchase a particular DDR (or make a trade having above a specified threshold value), the transaction may stay on hold until a parent approves the transaction. For example, the system may transmit a message to the parent indicating that the child has requested to purchase the DDR, and in some embodiments, the transaction may be approved and executed only after the parent approves the transaction, e.g., by clicking an appropriate link in the message, or by logging in and manually selecting and approving an indicia corresponding to the transaction. A subsequent confirmation message may be sent to the child account.

In some embodiments, parents or other adults may establish a sub-trading account, e.g., for children or minors. Parents may establish rules and parameters for such accounts—including dollar limits and restrictions on types of transactions—according to the account parameters and rule types described above. In some embodiments, the owner of the sub-account and all sub-account assets may be the parent instead of the child user, and so in some embodiments, it may not be necessary for a child to formally establish an account directly with a bank or the system, which in some cases could trigger Know Your Customer (“KYC”) laws and regulations.

In some embodiments, parents, teachers, schools, or other entities may specify rules that govern a child's behavior in the system. For example, rules may specify permissible hours for various users to engage in various types of activity such as trading, sending messages, or posting pictures (e.g., no activity or no trading during school hours).

In some embodiments, the system may provide a “mock” transaction system where users can learn to buy and trade financial instruments. The “mock” system may implement all features of the system using “fake” financial instruments and money instead of the real things. Fees may also be obtained through rounding the sizes of system transactions.

Revenue.

In some embodiments, the system may charge fees or otherwise earn revenue in various ways from various sources. The server may charge advertisers for advertising to users, e.g., ads presented in connection with any account behavior; sell user data (e.g., any information a user, including purchasing and trading behavior, and/or information about the user being classified as a trend setter or thought leader, etc.), e.g., to advertisers; sell information about “hot” or trending products, services, brands, or other trends; collect a broker fee on DDR and other financial transactions; charge account and other banking type fees (e.g., any analogous fee charged by a bank such as a fee for a checking account, monthly fee, overdraft fee, late fee, etc.); and/or contest entry fees. In some embodiments, fees may be charged to financial firms for gaining access to traders' information, e.g., preferences, geographic attributes, affiliations or aggregates of such or may be charged a message fee for contact. Recruiting institutions, educational or businesses may also be charged fees for information regarding members' performances or other attributes. Fees may be charged for the creation of new logos or access to a compendium of existing logos.

In some embodiments, one or more systems comprising hardware and software for accomplishing these methods is provided.

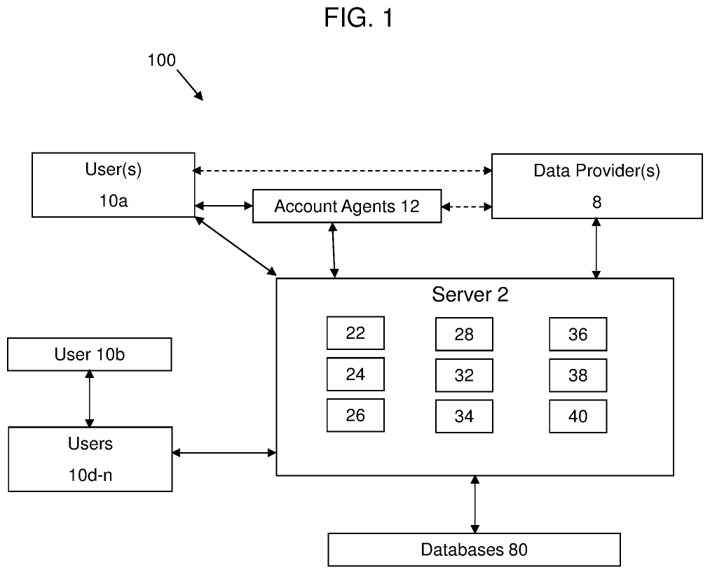

FIG. 1. Exemplary System

Some embodiments of the present invention provide systems and methods for enabling users to trade, e.g., using dollar depository receipts, and to create and manage single- and multi-user accounts.

The system 100 may comprise one or more servers 2 coupled to one or more databases 80, one or more data providers 8a-8n, one or more end users 10a-10n, and one or more account agents 12. The data providers 8a-8n, users 10, account agents 12, and server 2 may each communicate with each other. Users 10 may also communicate with other users 10, e.g., regarding one or more accounts.

Server 2 may comprise one or more processors, computers, computer systems, computer networks, and or computer databases. Server 2 may comprise modules 18-64. Server 2 may also comprise one or more databases, such as databases 80. Server 2 may communicate with users 10, data providers 8, and account agents 12. For instance, server 2 may communicate with a user 10 computer, such as a browser of a user computer, e.g., over the internet.

Databases 80 may comprise one or more processors, computers, computer systems, computer networks, and/or computer databases configured to store information. Each of databases 80 may communicate with server 2, e.g., via one or more modules of server 2. For instance, server 2 and modules may store information in databases 80 and may also use information stored in databases 80.

Users 10a-10n may comprise one or more human persons. Users may create and manage accounts, contribute assets to a single or group account, transfer assets from one account to another, specify and communicate parameters relating to an account, and/or otherwise interact with one or more other users, server, or data providers, or other elements of system 100. Users 10 may provide or receive information related to accounts associated therewith. Users 10 may interact with account agents 12, server 2, and/or other users 10 to create, manage, and settle accounts. As used in this application, users 10a-10n may also refer to a user's interface to other system 100 components (like server 2), such as a user's PDA or computer or a program running on a user's computer such as a computer web browser like Internet Explorer™, Chrome or Safari which may communicate with data providers 8, agents 12, and/or server 2.

Data provider(s) 8 may comprise any person, processor, information service, or other entity that publishes or otherwise provides information concerning or that may be relevant to one or more accounts, one or more users, one or more financial instruments, one or more assets, dollar depository receipts, and other information, such as a value (e.g., a price of a financial instrument or underlying asset thereof). The information may be provided to server 2, users 10, and/or account agents 12. For example, a data provider 8 may comprise an asset appraiser, data feed, ETF price provider (e.g., entity that provides real-time price updates and stock ticker information), data service, website, or other source of information relevant to an account or a user. In some embodiments, the data may include information that may be of interest to a user 10 or a user account, such as information about an upcoming event (e.g., a movie time) that is related to an account (e.g., an account created for a group of friends to pay for a movie).

Data provider 8 may provide information in real time, as information first becomes available to the general public, or at another time. Data provider 8 may provide such information in any one or more of a variety of forms and means such as video, audio (e.g., radio broadcast), text (e.g., stock ticker-type information), or other data that may convey such information. Data may be provided at a variety of different timings. In some embodiments, data may be provided in periodically, continuously, or continually, e.g., via a data feed (e.g., a stream of data that includes real time updates of event information, such as a running commentary of financial information in text or audio format). In some embodiments, data may be provided after an event, e.g., information about the weekend box office receipts of a movie related to an account.

In some embodiments, data provider 8 may provide to server 2 (and/or account agents 12 and/or users 10) information about an account, account asset, account purpose, account-related event, or other information. For example, data providers 8 may provide information regarding market information such as one or more prices of one or more financial instruments or other assets.

Account agents 12 may comprise one or more brokers, dealers, banks, account managers, account holders, or other parties who may handle one or more aspects of creating, managing, settling, and closing an account. Account agents 12 may comprise an entity that creates and manages dollar depository receipts. For example, account agents 12 may acquire one or more shares of a stock (e.g., stock of a publicly traded company), create a plurality of dollar depository receipts from the one or more shares, issue one or more of the dollar depository receipts to one or more users, enable users to buy, sell, and exchange the dollar repository receipts with one another and with account agent(s) (e.g., the issuing account agent), and to redeem dollar depository receipts. Account agents 12 may manage an account and provide account information to one or more other entities in the system such as server or users.

The server 2 may comprise a computer, server, hub, central processor, or other entity in a network, or other processor. The server 2 may comprise input and output devices for communicating with other various system 100 elements. In some embodiments, the server 2 may comprise a bank for holding and managing accounts and an exchange for trading financial instruments and other assets.

In some embodiments, the server 2 may be comprised in an end user's computer 10, e.g., as a toolbar in a user's web browser or another program running on the user's computer.

As shown in FIG. 1, the server 2 may comprise a plurality of modules, such as modules 22-34. Each module may comprise a processor as well as input and output devices for communicating with other modules, databases, and other system elements.

User interface module 22 may communicate with users. User interface module may communicate with users so that users can set up an account, log in to an account; prompt a user to submit preferences concerning other users and accounts (e.g., a preference to join accounts created by a member of the user's “friends” network that are related to movies); receive user preferences and selections concerning one or more works of art; communicate with users to provide information regarding one or more works of art.

User interface module 22 may cause information to be output to a user, e.g., at a user output device such as a display device (e.g., a display device at a user terminal), a speaker. The information outputted to a user may be related to a user account, one or more users or accounts, preferences (e.g., concerning users and accounts), and other information described herein. User interface module may communicate the information electronically, e.g., via networked communication such as the internet (e.g., in an email or webpage), telecommunication service, etc. In some embodiments, user interface module 22 may comprise input devices for users to information about one or more users or accounts, such as a request to view or create parameters governing a group account, pricing information (e.g., the current price or market value of a particular dollar depository receipt), and other information.

User preferences module 24 may receive, identify, or determine user preferences concerning one or more users and accounts. For instance, the module may receive the preferences from a user interacting with a user interface. The module may also receive the preferences from an automated user terminal. The module may also determine user preferences based on a program that automatically determines user preferences concerning one or more users, accounts, or assets (such as assets traded via server or otherwise traded on an exchange). User preferences may include preferences and other information that are related to, or that specify, any of the following with respect to one or more users, accounts, and assets: parameters, value information (e.g., historical and current price information), preferred trading partners, preferred users or “friends” for joining group accounts, preferences for viewing account information and receiving updates (e.g., updates concerning an account, such as a notification whenever a new person joins an account in which the user is a member), and other preferences.

Financial information module 26 may determine financial information associated with one or more users, accounts, and assets. For example, financial information module may determine a value of an account or an asset in an account, a purchase price of an asset in an account, account values of a group account and a user's portion (e.g., total portion or liquid portion) of one or more group accounts, changes in such values over time, and other financial information.

In some embodiments, financial instrument module 26 may manage the creation, issuance, exchange, and redemption of dollar depository receipts.

Payment module 28 may determine a payment (e.g., to be paid to or received by a user or server) for rights associated with one or more accounts, dollar depository receipts, or other assets.

Parameters module 30 may determine parameters and other information related to an account, such as rules governing the creation, management, and disposal of an account.

Asset search module 32 may search for and identify one or more dollar depository receipts or other assets, e.g., based on one or more search parameters. For instance, asset search module may search one or more financial databases, e.g., via the internet, to determine one or more dollar depository receipts or other assets that satisfy one or more parameters, such as parameters based on preferences from a user.

Price module 34 may determine and associate one or more values or prices with one or more accounts, portions of accounts, financial instruments such as dollar depository receipts, and other assets. For instance, price module may determine a price or value (such as a net present value) for a user's owned assets in a plurality of group accounts. Prices may include a current price, a historical price (e.g., a price such as a market price at a prior time, such as a week earlier or an original date of issuance of a dollar depository receipt), and an estimated future price (e.g., based on changing price information, such as a recent increase or decrease in a value of a particular dollar depository receipt).

Logo module 36 may store and manage custom logos of members, groups, leagues and company logos and constructed portfolio logos. The system may also provide for rules and procedures for registering logos for trademark protection. In addition the system may provide tools for the creation of new logos.

Trading module 38 may manage the issuance and secondary trading of DDRs and the trading of other financial instruments, e.g., in exchange for cash and/or other financial instruments or assets. Trading module may interface with users, brokers, trading exchanges, and other entities.

REPO module 40 may manage the creation, transacting, and enforcement of repo transactions.

Databases

As shown in FIG. 1, a database 80 may be coupled to the server 2. The database 80 may comprise a plurality of databases as described below. Databases 80 may store information about users, elements, and other information.

The modules may function separately or in various combinations. While the modules are shown within a single server, the modules may also operate among several servers. The modules may communicate with a plurality of databases, which may also function collectively or separately.

The modules of server 2 may store, access and otherwise interact with various sources of data, including external data, databases and other inputs.

Exemplary Methods

In some embodiments, an apparatus comprising at least one processor and a memory may accomplish the actions in the flow diagrams described herein. The memory may store one or more databases that store instructions that, when executed, direct the processor to perform various actions corresponding to various blocks below, e.g., in the disclosed order or another order.

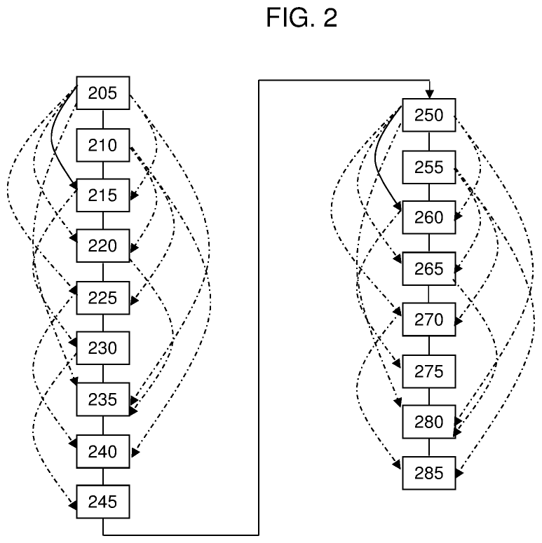

FIG. 2 depicts an exemplary flow diagram for creating and managing a group account according to at least one embodiment of the methods disclosed herein.

It should be understood that each function(s) described for each block may be performed using a module capable of performing that function, e.g., according to methods described for each module above. It should also be appreciated that the acts described in these blocks may be performed in any order (including but not limited to the exemplary orderings shown on the diagram), and not all blocks need be performed.

In block 205, a user may request another user to create an account. For example, a first user may send a message to a second user requesting that the second user create an account, e.g., for the second user, the first user, the first and second user, or another group of users. The request may comprise information about the accountholders and any parameters and rules as described herein. Based on the request, the system may prompt the other user to create the account.

In block 210, one or more users (such as the second user) may begin the process of creating an account. The system may cause a user interface to be displayed to the one or more users, e.g., that prompts the one or more users for information about the accountholders and the account parameters. The user may specify, e.g., at the user interface, one or more parameters associated with the account. For example, the user may specify parameters and/or rules that govern various features of the account, e.g., as described herein, such as parameters defining the accountholders, authorized traders, how to add or remove accountholders, etc.

In some embodiments, a group of users may collaboratively define parameters of an account. For example, the system may cause a plurality of account customization interfaces to be displayed to a group of users who are defining a group account (e.g., or a parent and child customizing a child's account linked to a parent account). Each user may suggest specific parameters that are then displayed to the other users, and the users may vote on each parameter.

In some embodiments, one user is designated as controller of the account. The other users may suggest parameters that appear on the controlling user's interface, and the controlling user makes or approves all final parameters for the account. In other words, some users may offer input, but the controlling user's selections and specifications for the account will control.

In block 215, the system may create the account, e.g., in accordance with the parameters specified by the one or more users.

In block 220, an accountholder may invite another user (or users) to join the account. For example, the accountholder may send a message to the other user. The message may comprise a selectable link or icon that, when selected by the other user, may enable the other user to join the account. In some embodiments, the message may comprise a password or other code that enables access to join the account. The message may also comprise requirements or other information about the account, for example, a required joining fee or required contribution to the account. For example, the message may specify that invited users may join the account by entering an authorization passcode and contributing $10 to the account.

In block 225, at least one of the invited one or more users may join the account. For example, an invited user may enter a passcode at an account website to join the account.

In block 230, an accountholder authorized to trade account assets may execute one or more trades in the account, e.g., for an investment portfolio in the account. For example, the authorized accountholder may buy or sell stocks, bonds, options, futures, DDRs, engage in REPO transactions, make loans, borrow funds, and perform other financial transactions for the account. Other authorized accountholders may similarly do trades for the portfolio. In some embodiments, the account may comprise multiple portfolios, each portfolio having one or more accountholders authorized to make trades for the portfolio.

In some embodiments, trading may be accomplished with other users of the system (e.g., who have different accounts). The system may track the trades and measure the financial performance of different portfolios and the trading decisions of different traders.

In some embodiments, bids and offers for trades may be submitted to an exchange (e.g., an exchange that works similarly in function and features to the New York Stock Exchange, NASDAQ, the eSpeed platform, or other trading exchanges), and the exchange may match bids and offers. Different order types may be submitted, such as limit orders, only at best orders, fill on close, immediate or cancel, and any other order type known in the art.

In block 235, an accountholder may spend or allocate account funds for an event, such as a pizza party and/or movie tickets for a movie night. For example, the accountholder may spend half of the account funds to purchase movie tickets for participating accountholders for a Friday night movie. In some embodiments, non-participating accountholders (e.g., who do not attend the movie) may redeem a portion of account funds, e.g., redeem the price of a movie ticket (or portion thereof) since they are not participating in the movie or pizza.

In some embodiments, such events or other account fund allocations and rules governing such allocations may be specified at the time of creating the account. In some embodiments, only certain accountholders (or non-accountholders, such as a parent of a child accountholder) may be authorized to allocate account funds for special purposes. Such authorized accountholders may be the same or different as authorized traders. In some embodiments, accountholders authorized to allocate funds may have limited trading authority to sell account assets (such as stock or DDRs) in order to obtain cash needed for the special purpose or allocation. In some embodiments, such accountholders may have limited authority to trade for such special purposes, e.g., trade DDRs for movie tickets.

In block 240, an accountholder may request a full or partial redemption of the accountholder's portion of the account assets. In some embodiments, an authorized accountholder may execute a redemption, e.g., by transferring the relevant amount of cash or other assets (e.g., DDRs) to the accountholder's individual account. In some embodiments, the system may automatically authorize such redemptive transfers by authorized accountholders, e.g., up to a certain limit (e.g., 50% or 100% of the accountholder's portion of the account). In this way, accountholders may partially or wholly “cash out” of the account. In some embodiments, a user who “cashes out” completely will automatically be removed from the account. In other embodiments, such accountholder will remain a member of the account, e.g., keeping full (or partially restricted) account access.

In block 245, an authorized accountholder may approve the request for full or partial redemption.

In block 250, an accountholder may leave the account. In some embodiments, the accountholder may first request to leave the account, and then an authorized accountholder may approve the request. In some embodiments, a portion of the account may transferred to an account of the departing accountholder, e.g., to “cash out” or redeem the departing accountholder's ownership of the account. (For example, the accountholder may own 11% of the account, e.g., based on the accountholder's contribution of 11% of the account assets when the account was set up, or based on other criteria and circumstances such as the departing accountholder's trading, transfers, and other activity in the account). Such transfer may be performed automatically, e.g., in response to the accountholder's request to leave the account, or in response to an authorized accountholder's approval of a request to leave.

In some embodiments, the account may not have sufficient cash or liquid funds to “cash out” or redeem the departing accountholder's portion of the account. In other embodiments, the account may automatically liquidate assets, e.g., by selling financial instruments owned by the account. In some embodiments, the system may automatically propose such sales or other trades, and an authorized trader on the account may approve the proposed trade.

In some embodiments, the departing accountholder may receive a lien or an “IOU” from the account. The account may automatically satisfy the lien or “IOU” when liquid funds become available.

In some embodiments, the account may redeem the departing accountholder with non-liquid (or less liquid) assets. In some embodiments, the account may redeem the departing accountholder with cash and/or financial instruments, such as stock, DDRs, and/or other instruments.

In block 255, account parameters may be modified, e.g., by one or more users authorized to modify parameters. In some embodiments, account information may be output to users, such as account balance, names of accountholders, logo(s) associated with the account or one or more users of the account, recent transactions, current settings and parameters, upcoming activities relevant to the account (e.g., pizza party), and other information.

In block 260, one or more accountholders may communicate with one or more other accountholders and/or non-accountholders. For example, an accountholder may send a message inviting one or more non-accountholders to join the account. A non-accountholder may “like” the account by clicking on a “like” indicia associated with the account, and information about the “like” may be broadcast to one or more other users, such as the “liking” user's connections in a social network. Other social network communications such as those known in Facebook, MySpace, Friendster, Instagram, and Twitter are also contemplated herein.

In some embodiments, users may post tutorials and other videos and other content, and other users may view and rate such videos and content.

In block 265, the system may determine information based on user and account activity and communications. For example, the system may determine information about user preferences (e.g., for targeting ads), determine what products, brands, or companies are “hot” or trending, determine rating scores for content such as videos (e.g., based on reviewing scores and number of downloads, for example), and determine financial performance scoring and other information for different users, portfolios, accounts.

In block 270, some or all of this information may be provided to one or more users. For example, an indicia of a user video available for view may indicate a user rating score for the video (e.g., in a range of categories). Rankings of the “best traders” according to one or more metrics (such as highest internal rate of return) may be published, e.g., for users or a subset of users (such as users from a particular school, city, state, age, etc.). The system may also publish a “trending” list. The system may cause targeted advertisements to be displayed to users based on tracked information.

In some embodiments, the system may automatically send such “suggested” accounts that a user may be interested in joining, e.g., based on the user's preferences.

In block 275, an account may create a mutual fund, e.g., comprising a portfolio of securities. In some embodiments, users such as accountholders may be issued shares of the mutual fund.

In block 280, a portfolio of one account may be combined with one or more portfolios of one or more other accounts. For example, multiple accounts may be combined into a single account. In some embodiments, the two accounts may retain separate account identities, but share ownership of the assets of the account. In some embodiments, one account may be a “dominant” account (such as the larger account, or the account owning the larger share of the mutual fund, or the account that starts the mutual fund) that controls and manages the combined mutual fund. The mutual funds may be combined responsive to a request to combine from an accountholder of one of the mutual funds to an accountholder of the other mutual fund.

In block 285, an accountholder may start a second account, e.g., as described herein. The second account may be linked to the original account. The second account may have different parameters, e.g., including different accountholders. The accountholder may invite one or more others to join the account.

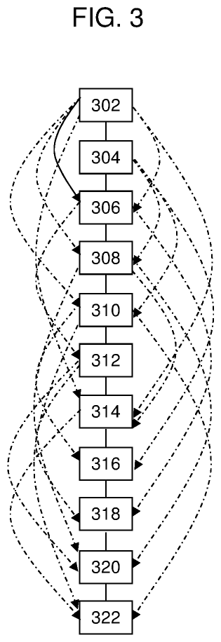

FIG. 3 depicts a flow diagram for issuing and trading dollar depository receipts according to at least one embodiment of the methods disclosed herein.

In block 302, a party such as an intermediary may buy one or more units of a financial instrument, such as a plurality of shares of IBM stock. The shares may be stored in an account.

In block 304, one or more Dollar Depository Receipts (“DDR”) based on the financial instrument may be created. Electronic records corresponding to the DDR may be stored and tracked.

In block 306, one or more of the DDRs may be offered for sale in an initial offering.

In block 308, one or more users may purchase one or more DDRs.

In block 310, one or more users may offer to purchase or sell one or more of the DDRs, e.g., in secondary trading via an exchange. In some embodiments, a user may submit the offer to one or more other users, one or more brokers (e.g., such as the issuing broker), an exchange, or another entity.

In block 312, a DDR may be transferred from one account (e.g., group account) to another account, e.g., responsive to a request.

In block 314, one user may propose a REPO transaction, e.g., to a second user. The proposal may specify an amount of funds to be exchanged for an amount of assets (e.g., such as one or more DDRs and other financial instruments in the account or another account), an interest rate or fee, and a time or duration such as a settlement date. In some embodiments, settlement dates may be extended upon consent by both parties.

In block 316, the second user may accept the request to engage in a repo transaction.

In block 318, one or more DDRs (and/or other financial instruments) may be used in a REPO transaction. The system may facilitate the exchange of funds and assets (and charge fees) pursuant to the repo terms.

In block 320, one or more DDRs may be redeemed, e.g., for cash. For example, a $10 face IBM DDR that is currently worth $14 may be redeemed (e.g., from a broker who created the DDRs or another entity) for $14, or an amount close to $14 minus a service or transaction fee, or other amount. In some embodiments, fractional amounts may be addressed as elsewhere described herein.

In block 322, one or more DDRs may be redeemed for a financial instrument. For example, DDRs of IBM shares having a face, market, or other determined value of $100 may be redeemed for a share of IBM (or another security) that has a determined value (e.g., market value) of $100. In some embodiments, a plurality of DDRs may be “redeemed” back for the original security from which they were derived. The DDRs may be exchanged for the financial instrument.

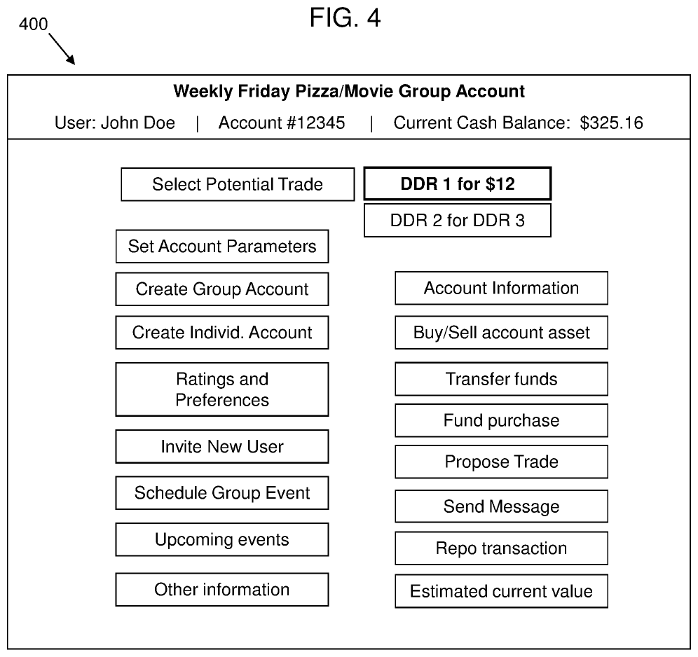

FIG. 4 depicts an exemplary interface for creating and managing an account according to at least one embodiment of the methods disclosed herein. As shown in interface 400, which may comprise a website, a user may select various buttons/icons to perform various features. For example, different buttons/icons may comprise: select potential trade, set account parameters/rules, create another individual or group account, view or modify ratings (e.g., of user content, account performance, accountholder trading performance, view or modify preferences (e.g., account preferences, stocks of interest), schedule group events, view upcoming events (such as group events), view account information, buy or sell an account asset (such as a DDR in the account), transfer funds (e.g., to another user or account, e.g., in exchange for consideration), fund a purchase (e.g., buy movie tickets or pizza using account funds), propose a trade (e.g., propose an exchange of funds/assets for funds/assets of another account), send a message to one or more users or accountholders, propose or configure a repo transaction, view current account value, and view other information. It should be appreciated that the interface may comprise any suitable interface via any suitable medium (e.g., computer or smartphone) to configure, view, and/or communicate any parameter, proposal, preference, or other information disclosed herein.

In some embodiments, account assets must satisfy eligibility criteria to be eligible for contribution to a group account. For example, an asset may be eligible for participation in the account only if it is determined to have a value above a particular threshold, e.g., a monetary or appraisal value greater than $100.

It should be appreciated that while many embodiments are described herein with respect to real money and real financial instruments, various embodiments may be equally practiced using simulated funds and simulated financial instruments, e.g., wherein no real money is used. In this way, users may gain valuable practice handling funds and trading without incurring real legal consequences or financial harm.

It should be appreciated that various embodiments of the invention use some or all of the actions described in the blocks of the flowcharts described herein, and/or in combination with any other action described herein. Further, the actions described in those blocks may be performed in the order listed, or in any other order.

It should be appreciated that all prompts, requests, and other communications may be transmitted electronically as emails, text messages, voice communications, instant messages, and other methods of communication known in the art. It should also be appreciated that various method steps described herein may be accomplished by humans, a computer without human intervention, or a computer with human intervention.

It should be appreciated that the system may store all information described herein, prompt one or more users or other relevant parties for all inputs described herein (e.g., via a computer interface), and receive all inputs described herein, e.g., via a computer interface.

### XII. ALTERNATIVE TECHNOLOGIES

It will be understood that the technologies described herein for making, using, or practicing various embodiments are but a subset of the possible technologies that may be used for the same or similar purposes. The particular technologies described herein are not to be construed as limiting. Rather, various embodiments contemplate alternate technologies for making, using, or practicing various embodiments.

Modifications, additions, or omissions may be made to the method without departing from the scope of the invention. The method may include more, fewer, or other steps. Additionally, steps may be performed in any suitable order without departing from the scope of the invention.

While this disclosure has been described in terms of certain embodiments and generally associated methods, alterations and permutations of the embodiments and methods will be apparent to those skilled in the art. Accordingly, the above description of example embodiments does not constrain this disclosure. Other changes, substitutions, and alterations are also possible without departing from the spirit and scope of this disclosure, as defined by the claims herein.

1. (canceled)

2. A method comprising:
receiving, by at least one processor of at least one computer in electronic communication with a plurality of other computers via an electronic communications network, from a first computing device an instruction to create an account;
receiving, by the at least one processor, from the first computing device a designation of a plurality of accountholders of the account;
receiving, by the at least one processor, from the first computing device a designation of a subset of the plurality of accountholders authorized to withdraw funds out of the account;
receiving, by the at least one processor, from the first computing device, authorization information about one or more accountholders authorized to trade assets in the account, the authorization information indicating that a user is authorized to trade assets in the account;
receiving, by the at least one processor, from the first computing device a designation of rules specifying how accountholders may be added or removed from the account;
causing, by the at least one processor, the account to be activated;
after causing the account to be activated, receiving from each of a plurality of accountholders an instruction to transfer funds from the respective accountholder to the account;
after causing the account to be activated, receiving, by the at least one processor, from a second computing device that is associated with the user, a request to trade an asset of the account;
identifying, by the at least one processor, whether the request to trade an asset of the account includes data indicative of a request to sell a financial instrument in the account, a request to purchase a financial instrument for the account, or a request to exchange at least a portion of a financial instrument in the account for at least a portion of another financial instrument outside the account;
determining, by the at least one processor, that the second computing device is authorized to request to trade an asset of the account based on the received authorization information;
responsive to determining that the second computing device is authorized to request to trade an asset of the account based on the received authorization information, causing, by the at least one processor, the requested trade to occur;
after causing the account to be activated, adding, by the at least one processor, a new accountholder to the account in accordance with the rules specifying how accountholders may be added or removed;
receiving, by the at least one processor, a video tutorial about a financial concept from an accountholder of the account;
causing, by the at least one processor, an indicia of the video to be displayed to a plurality of users;
receiving, by the at least one processor, a selection of the indicia by a user;
responsive to the selection, causing, by the at least one processor, the video to be displayed to the user;
causing, by the at least one processor, a rating indicia associated with the video to be displayed to the user;
receiving, by the at least one processor, a selection of the rating indicia;
responsive to receiving a selection of the rating indicia, prompting, by the at least one processor, the user for rating information about the video; and
receiving, by the at least one processor, rating information about the video.

3. The method of claim 2, in which the request to trade an asset of the account comprises a request to sell a financial instrument in the account, further comprising:
receiving, by the at least one processor, a request to use account assets in a repo transaction; and
causing, by the at least one processor, the repo transaction to occur, in which the request to use account assets in a repo transaction comprises defining an interest rate, an expiration date of the repo transaction, an account asset subject to the repo transaction, and an asset outside of the account that is subject to the repo transaction.

4. The method of claim 2, in which the request to trade an asset of the account comprises a request to purchase a financial instrument for the account, further comprising:
before causing the requested trade, determining, by the at least one processor, whether account parameters specify that the second computing device is authorized to make the requested trade.

5. The method of claim 2, further comprising:
receiving from a party a request to use one or more assets in the account pursuant to a proposed sale and repurchase agreement (repo).

6. The method of claim 2, further comprising:
receiving from the second computing device an instruction to enter into the proposed sale and repurchase agreement and to transfer the requested one or more assets to the party pursuant to the agreement, in which the sale and repurchase agreement defines account assets to be transferred, an amount of money to be transferred into the account, an interest rate or interest payment amount, and a future settlement date;
responsive to the instruction, causing, by the at least one processor, the money to be transferred from the party to the account;
responsive to the instruction, causing, by the at least one processor, the amount of money to be transferred into the account;
on the settlement date, causing, by the at least one processor, the one or more assets to be transferred from the party back to the account; and
on the settlement date, causing, by the at least one processor, the amount of money plus an interest amount to be transferred from the account to the party.

7. The method of claim 2, further comprising:
receiving, by the at least one processor, from the first computing device, a designation of a rule that at least one of:
specifies initial requirements that must be met before the account can be created;
specifies a minimum amount of funds that must be contributed to the account before it can be activated;
specifies a minimum number of users who must join the account before it can be activated;
specifies how ownership of account assets will be distributed among accountholders;
specifies managerial fees for managing the account;
specifies which accountholders are authorized to trade account assets for other assets;
specifies how and when an accountholder may redeem funds in the account based on a portion of the account owned by said accountholder;
specifies a limit on the a value of assets in the account that may be traded;
specifies a restriction on the types of assets that may be purchased using account funds;
concerns the a display of account information to accountholders;
governs how a logo associated with the account may be determined by accountholders;
specifies counterparties that may not trade with the account;
governs the a combining of assets of the account with assets of another account;
governs the a combining of the account with another account;
governs how accountholders earn points redeemable for value;
governs how to measure a financial performance of a portfolio of the account;
specifies penalties that will be assessed against accountholders for a plurality of offending behaviors; and
specifies conditions for adding and removing accountholders from the account.

8. The method of claim 2, further comprising:
determining, by the at least one processor, information about an accountholder based on account activity by the accountholder and communications from the accountholder;
selecting, by the at least one processor, one of a plurality of advertisements for the accountholder based on the information determined about the accountholder; and
causing, by the at least one processor, the selected advertisement to be communicated to the accountholder.

9. The method of claim 8, further comprising:
receiving rating information for a plurality of videos uploaded by a plurality of users including the accountholder;
aggregating the rating information received for each video;
determining a highest rated video from among the plurality of videos, in which the determined highest rated video comprises the video received from the accountholder; and
causing a listing of highest rated videos to be displayed, the listing comprising an identification of the video as the highest rated video.

10. The method of claim 2, further comprising:
receiving rating information about a plurality of logos, each logo associated with an account;
based on the rating information, determining a highest rated logo; and
awarding a benefit to an account associated with the highest rated logo.

11. The method of claim 2, further comprising:
receiving from an account holder a request to allocate account funds to a group event;
communicating the request to allocate account funds to a group event to an accountholder authorized to allocate funds of the account;
receiving from the accountholder authorized to allocate funds to the account an instruction to allocate funds to the group event; and
causing the funds to be allocated to the group event.

12. An apparatus comprising:
at least one processor of at least one computer in electronic communication with a plurality of other computers via an electronic communications network; and
at least one memory having instructions stored thereon which, when executed, direct the at least one processor to:
receive, from a first computing device, an instruction to create an account;
receive, from the first computing device, a designation of a plurality of accountholders of the account;
receive, from the first computing device, a designation of a subset of the plurality of accountholders authorized to withdraw funds out of the account;
receive, from the first computing device, authorization information about one or more accountholders authorized to trade assets in the account, the authorization information indicating that a user is authorized to trade assets in the account;
receive, from the first computing device, a designation of rules specifying how accountholders may be added or removed from the account;
cause the account to be activated;
after the account has been activated, receive from each of a plurality of accountholders an instruction to transfer funds from the respective accountholder to the account;
after the account has been activated, receive from a second computing device a request to trade an asset of the account;
identify whether the request to trade contains data indicative of a request to sell a financial instrument in the account, a request to purchase a financial instrument for the account, or a request to exchange at least a portion of a financial instrument in the account for at least a portion of another financial instrument outside the account;
determine that a user associated with the second computing device is authorized to request to trade an asset of the account based on the received authorization information;
responsive to determining that the user is authorized to request to trade an asset of the account based on the received authorization information, cause the requested trade to occur;
after the account has been activated, add a new accountholder to the account in accordance with the rules specifying how accountholders may be added or removed; receive a video tutorial about a financial concept from an accountholder of the account;
cause an indicia of the video to be displayed to a plurality of users;
receive a selection of the indicia by a user;
responsive to the selection, cause the video to be displayed to the user;
cause a rating indicia associated with the video to be displayed to the user;
receive a selection of the rating indicia;
responsive to receiving a selection of the rating indicia, prompt the user for rating information about the video; and
receive rating information about the video.

13. A non-transitory computer-readable medium having instructions stored thereon that are configured to cause at least one processor of at least one computer in electronic communication with a plurality of other computers via an electronic communications network to:
receive, from at least one computing device, an instruction to create an account;
receive, from a first computing device, a designation of a plurality of accountholders of the account;
receive, from the first computing device, a designation of a subset of the plurality of accountholders authorized to withdraw funds out of the account;
receive, from the first computing device, authorization information about one or more accountholders authorized to trade assets in the account, the authorization information indicating that a second user is authorized to trade assets in the account;
receive, from the first computing device, a designation of rules specifying how accountholders may be added or removed from the account;
cause the account to be activated;
after the account has been activated, receive from each of a plurality of accountholders an instruction to transfer funds from the respective accountholder to the account;
after causing the account to be activated, receive from a second computing device a request to trade an asset of the account
identify whether the request includes data indicative of a request to sell a financial instrument in the account, a request to purchase a financial instrument for the account, or a request to exchange at least a portion of a financial instrument in the account for at least a portion of another financial instrument outside the account;
determine that a user associated with the second computing device is authorized to request to trade an asset of the account based on the received authorization information;
responsive to determining that the user is authorized to request to trade an asset of the account based on the received authorization information, cause the requested trade to occur;
after causing the account to be activated, add a new accountholder to the account in accordance with the rules specifying how accountholders may be added or removed;
receive a video tutorial about a financial concept from an accountholder of the account;
cause an indicia of the video to be displayed to a plurality of users;
receive a selection of the indicia by a user;
responsive to the selection, cause the video to be displayed to the user;
cause a rating indicia associated with the video to be displayed to the user;
receive a selection of the rating indicia;
responsive to receiving a selection of the rating indicia, prompt the user for rating information about the video; and
receive rating information about the video.
